(19) United States
(12) Patent Application Publication
(10) Pub. No.: US 2016/0292601 A1
(43) Pub. Date: Oct. 6, 2016

(54) DELEGATION OF TASKS TO OTHER PERSONNEL IN AN ERP APPLICATION

(71) Applicant: Oracle International Corporation, Redwood Shores, CA (US)

(72) Inventor: Sriram Pakanathi, Hyderabad (IN)

(21) Appl. No.: 14/672,259

(22) Filed: Mar. 30, 2015

(51) Int. Cl. G06Q 10/06; H04L 29/06

(52) U.S. Cl. CPC G06Q 10/06311; H04L 63/08

(57) ABSTRACT

Aspects of the present disclosure provide for delegating tasks, where an administrator specifies a first set of tasks that can be delegated and a class of permissible delegatees to whom the first set of tasks can be delegated. The first set of tasks and the class of delegatees are added to a permitted delegations list. A request is received from a delegator to delegate a task to a delegatee. The request is examined in view of the permitted delegations list to determine whether the request is permitted, and if permitted, the task and delegatee are added to a delegated list. A second request is received from a first user to operate as a delegatee for a second user. The request is examined in view of the delegated list, and if permitted, the first user is enabled to operate as delegatee for a set of tasks assigned to the second user.

### BACKGROUND

1. Technical Field

The present disclosure relates to access management in enterprise applications, and more specifically to enabling delegation of tasks to other personnel in an enterprise resource planning (ERP) application.

2. Related Art

Enterprise resource planning (ERP) applications are used in organizations or enterprises for coordinating and controlling various activities. The range of activities can span diverse and yet related areas such as human resources management, product planning, marketing/sales, inventory management, shipping/payment, etc., as is well known in the relevant arts. Each of such areas is often provided as a corresponding application/module of an ERP system, such that organizations can choose applications relating to only the specific areas that are of interest to the corresponding organization.

Each organization typically employs several personnel as employees, contractors, etc. These personnel are required to perform several tasks for effective operation of the organization. For example, one of the managers may be required to approve invoices. While approving invoices generally may be referred to as the ‘task’, the approval of each particular invoice may be referred to as a ‘task instance’.

Typically, a person may be assigned a task (e.g., approving invoices, managing purchase data, etc.) and thereafter the person may be required to address the task instances of that task (e.g., approving a particular invoice, entering data related to a specific purchase on a form, etc.).

There is often a need to delegate tasks (including instances) to other personnel of an enterprise. For example, when a manager is temporarily unavailable for reasons such as travel or vacation, the manager (acting as a delegator) may wish to delegate some administrative responsibilities to an assistant (who would be the delegatee), and some other responsibilities to another manager (another delegatee). Aspects of the present disclosure relate to such delegation of tasks to other personnel in an ERP application.

### BRIEF DESCRIPTION OF THE DRAWINGS

Example embodiments of the present disclosure are described with reference to the accompanying drawings briefly described below.

FIG. 1 is a block diagram illustrating an example environment in which several aspects of the present disclosure can be implemented.

FIG. 2A is a flow chart illustrating the manner in which an organization, via an administrator, may control delegation of tasks, according to an aspect of the present disclosure.

FIG. 2B is a flow chart illustrating the manner in which a delegatee is enabled to act as a proxy for a delegator, according to an aspect of the present disclosure.

FIG. 3 is a block diagram illustrating the detailed architecture of an ERP system in an embodiment.

FIGS. 4A-4B together depict user interfaces that may be provided for an administrator to specify specific responsibilities that may be delegated in one embodiment.

FIGS. 4C-4D together depict user interfaces that may be provided for an administrator to specify permissible delegatees in one embodiment.

FIG. 4E depicts a user interface that may be provided for an administrator to specify specific responsibilities that may not be delegated in one embodiment.

FIG. 5A depicts a user interface that may be provided for a delegatee to login to the ERP system in one embodiment.

FIG. 5B depicts a user interface that may be provided for a delegatee to view the delegatee's home page in an ERP application in one embodiment.

FIG. 5C depicts a user interface that may be provided for a delegator to login to the ERP system in one embodiment.

FIG. 5D depicts a user interface that may be provided for a delegator to view the delegator's home page in an ERP application in one embodiment.

FIGS. 5E-5M together depict various user interfaces that may be provided for the delegator to delegate responsibilities to the delegatee in one embodiment.

FIGS. 5N-5P together depict various user interfaces that may be provided for the delegatee to switch roles as a delegator and to view the delegated responsibilities in one embodiment.

FIG. 5Q depicts a user interface that may be provided to the delegator to review various delegatee actions in one embodiment.

FIG. 6 is a block diagram illustrating the details of a digital processing system in which several aspects of the present disclosure are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. Overview

Aspects of the present disclosure provide for delegating tasks, where an administrator specifies a first set of tasks that can be delegated and a class of permissible delegatees to whom said first set of tasks can be delegated. The first set of tasks and the class of delegatees are added to a permitted delegations list. Thereafter, a request is received from a delegator to delegate a task to a delegatee. The request is examined in view of the permitted delegations list to determine whether the request is permitted, and if the request is permitted, the task and the delegatee are added to a delegated list.

A second request is subsequently received from a first user to operate as a delegatee for a second user. The request is examined in view of the delegated list, and if it is determined that the first user is permitted to be a delegatee for the second user, and the first user to enabled to operate as a delegatee for a set of tasks assigned to the second user.

According to another aspect of the present disclosure, when additional responsibilities (including corresponding tasks) are integrated into a new application, these responsibilities are automatically available for the administrator to control and for the delegator to thereafter delegate.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

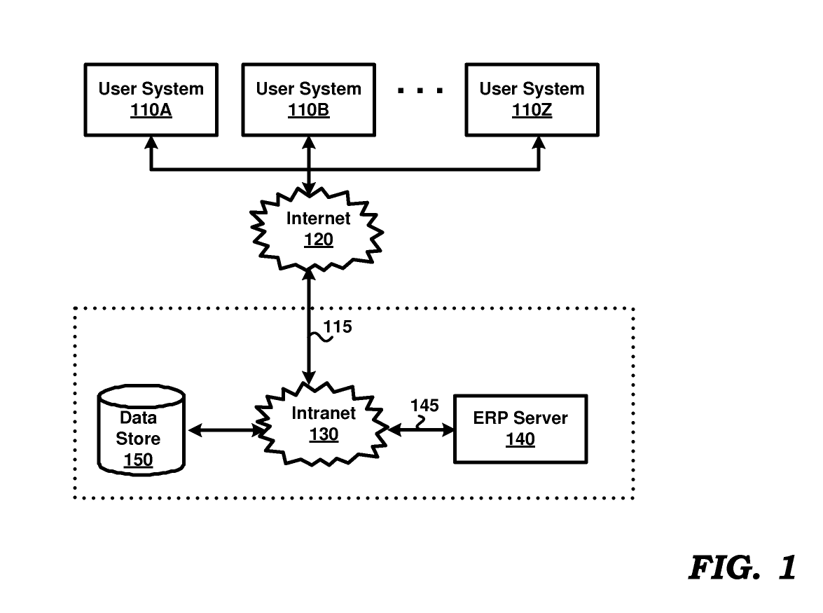

FIG. 1 is a block diagram illustrating an example environment in which several aspects of the present disclosure can be implemented. The block diagram is shown containing user systems 110A-110Z, Internet 120, intranet 130, ERP server 140, and data store 150.

Merely for illustration, only representative number/types of systems are shown in the Figure. Many environments often contain many more systems, both in number and type, depending on the purpose for which the environment is designed. Each system/device of FIG. 1 is described below in further detail.

Intranet 130 represents a network providing connectivity between data store 150 and ERP server 140, provided within an enterprise (shown with dotted boundaries). Internet 120 extends the connectivity of these (and other systems of the enterprise) with external systems such as user systems 110A-110Z.

Each of intranet 130 and Internet 120 may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by intranet 130 and Internet 120. When the packet contains content such as port numbers, which specifies the destination application, the packet may be said to be directed to such application as well. The destination system may be required to keep the corresponding port numbers available/open, and process the packets with the corresponding destination ports. Each of Internet 120 and intranet 130 may be implemented using any combination of wire-based or wireless mediums.

Each of user systems 110A-110Z represents a system such as a personal computer, workstation, mobile station, mobile phones, computing tablets, etc., used by users to send user requests to applications executing on ERP server 140 via Internet 120 and intranet 130, and display the corresponding responses. The responses may be in the form of web pages and thus the requests may be in the form of Uniform Resource Locators (URLs). Each user system may accordingly execute browser software for such interactions. Alternatively, the interactions may be based on custom packet interactions, according to any pre-specified protocol interfaces.

Data store 150 represents a non-volatile (persistent) storage facilitating storage and retrieval of data by applications executing in other systems of the enterprise such as ERP server 140. For example, data store 150 may be implemented to store data, which would be of interest to users operating user systems 110A-110Z. Data store 150 may be implemented as a database server using relational database technologies and accordingly provide storage and retrieval of data using structured queries such as SQL (Structured Query Language). Alternatively, or in addition, data store 150 may be implemented as a file server providing storage and retrieval of data in the form of files organized as one or more directories, as is well known in the relevant arts.

ERP server 140 represents a server capable of performing acts requested by users using user systems 110A-110Z. In a typical implementation, ERP server 140 hosts enterprise applications capable of performing actions requested by users using user systems 110A-110Z. In response to receiving requests from users at user systems 110A-110Z, a corresponding enterprise application performs the actions specified in the requests and sends the result of performance of the actions to the requesting user system. As noted in the background section, each enterprise application may be designed for addressing a corresponding specific area of activities, and different personnel may be assigned tasks consistent with the general responsibilities each person/user is assigned. Each user may cause requests to be generated in performing the related tasks, and ERP server performs the actions corresponding to the requests, including sending the results of the performed tasks.

As also noted above, some of the personnel may wish to delegate tasks. It may be desirable for organizations to control various aspects of delegation of tasks. Aspects of the present disclosure provide for such control, as described below with examples.

### 3. Flowchart

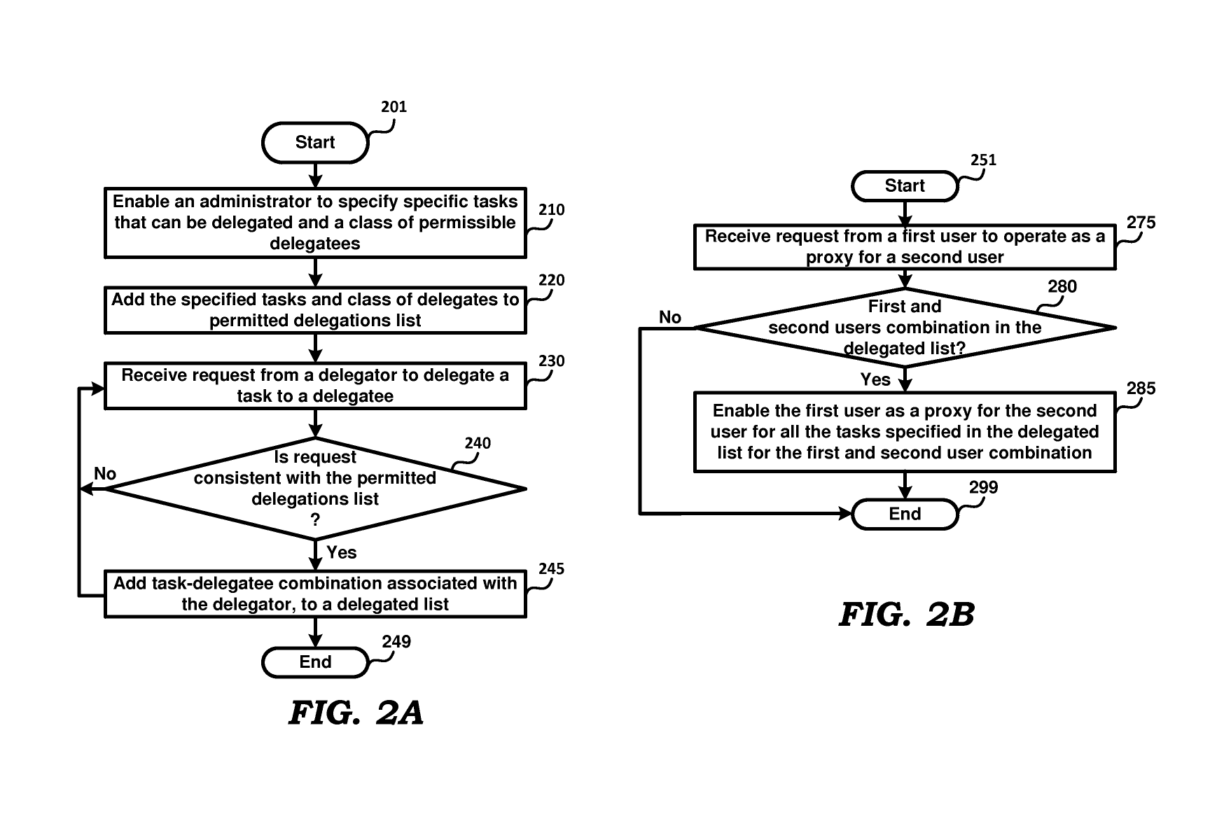

FIGS. 2A and 2B together illustrate the manner in which an organization, via an administrator, may control delegation of tasks, according to an aspect of the present disclosure. The flowcharts are described with respect to the systems of FIG. 1, especially ERP server 140, merely for illustration. However, the features can be implemented in other systems and environments also without departing from the scope and spirit of various aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart of FIG. 2A begins in step 201, in which control immediately passes to step 210.

In step 210, an administrator specifies specific tasks that can be delegated and a class of permissible delegatees to whom the tasks can be delegated in ERP server 140. Such specification can be in the form of negative rules (i.e., what is not permitted), positive rules (what is permissible), and/or combination of both.

As noted earlier, examples of specific tasks may be approving invoices, managing purchase data, etc. A class of permissible delegates may be any group of personnel who can be characterized by a common trait. Examples of classes include: direct line of command (personnel who may be direct reportees), second line of command (personnel who may report to the direct reportees), third line of command (personnel who may report to the second line of command personnel), all users, immediate supervisor and their peers (personnel who qualify as a supervisor or who have similar tasks as a supervisor), and supervisor's supervisor and his peers (personnel to whom the supervisor or his/her peers report to). Alternatively or in addition, the permissible delegates can be a specific list of individuals. The specific tasks also can be specified at a higher level of abstraction (e.g., tasks falling under a responsibility).

In step 220, the specified tasks and class of permissible delegatees are added to a permitted delegations list in ERP server 140. For example, if the specific task that can be delegated is approving of invoices and the specific class that is permitted as delegatees is direct line of command, the permitted delegation list will maintain entries that specify that any user with the task of approving invoices may delegate the task to any of his/her direct line of command personnel (i.e., direct reportees). In embodiments described below, administrator specifies a pair of task and permissible delegatees, and accordingly the specified task and delegates are stored in association. However, in alternative embodiments, the delegatees and tasks may be specified independently, either in addition or in alternative. In an embodiment, the permitted delegations list may be in the form of a table, with each pair of tasks and permissible delgatees stored as a row in the table.

In step 230, ERP server 140 receives a request from a delegator (i.e., a first user who wishes to delegate) to delegate a task to a delegate (another user who can operate as a proxy for the first user, as described below). For example, a manager may wish to delegate the task of approving invoices to an assistant.

In step 240, ERP server 140 determines whether the request for delegation is consistent with the permitted delegations list of step 220. A request is deemed to be consistent with the permitted delegations list if the rules are interpreted to permit the delegation (of the task to the specified delegate) specified in the request.

If the request is consistent, control passes to step 245. Otherwise, control passes to step 230 where a new request for delegation is awaited. For example, since an assistant will be in the class of ‘direct line of command’ personnel, and since the task of approving invoices by direct line of command personnel would have been maintained in the permitted delegations list (per the above steps), ERP server 140 would determine that the request for delegation is consistent with the permitted delegations list, and pass control to step 245.

In step 245, the delegator-task-delegatee combination is added to a delegated list in ERP server 140. For example, the identity of the delegator (i.e., the manager), the identity of the task (i.e., approving invoices), and the identity of the delegatee (i.e., the assistant job function/code) would be added to the delegated list. In an embodiment, the delegated list may be in the form of a table, with each combination of delegator-task-delegatee stored as a row in the table. The delegator-task-delegatee combination may be referred to as a proxy relationship, where the delegator would enable a delegatee to serve as a proxy for the specific tasks so identified. Thereafter, control passes to step 249, in which the flow chart of FIG. 2A ends.

Once the delegated list is thus formed by an administrator, the flow chart of FIG. 2B is operative to enable a user to serve as a proxy to another user, provided the proxy relationship is specified in the delegation list, as described below.

The flow chart of FIG. 2B begins in step 251, in which control immediately passes to step 275. In step 275, ERP server 140 receives a request from a first user to operate as a proxy for a second user. With reference to the above example, the first user would be the assistant and the second user would be the manager.

In step 280, ERP server 140 determines whether the combination of first and second users (as delegator and delegatee respectively) is in the delegated list (see step 245 of FIG. 2A). If the combination is in the delegated list, control passes to step 285. Otherwise, control passes to step 299 where the flowchart ends. With reference to the above example, since the combination of the manager and the assistant is in the delegated list (see step 245 of FIG. 2A), control passes to step 285.

In step 285, ERP server 140 enables the first user as a proxy for the second user for all the tasks specified in the delegated list for the first and second user combination (as delegator and delegatee respectively). With reference to the above example, the assistant is enabled as a proxy for the manager so that the assistant is able to perform all the tasks specified in the delegated list for the manager-assistant combination.

Thus, in accordance with FIGS. 2A and 2B, an organization, via an administrator, may control delegation of tasks by specifying specific tasks that may be delegated along with the class of delegatees to whom the tasks may be delegated. Further, a user is enabled to serve as a proxy to another user provided the proxy relationship is specified in the delegation list maintained by the ERP server 140.

The description is continued with respect to the details of ERP system 140 in an embodiment.

### 4. ERP System

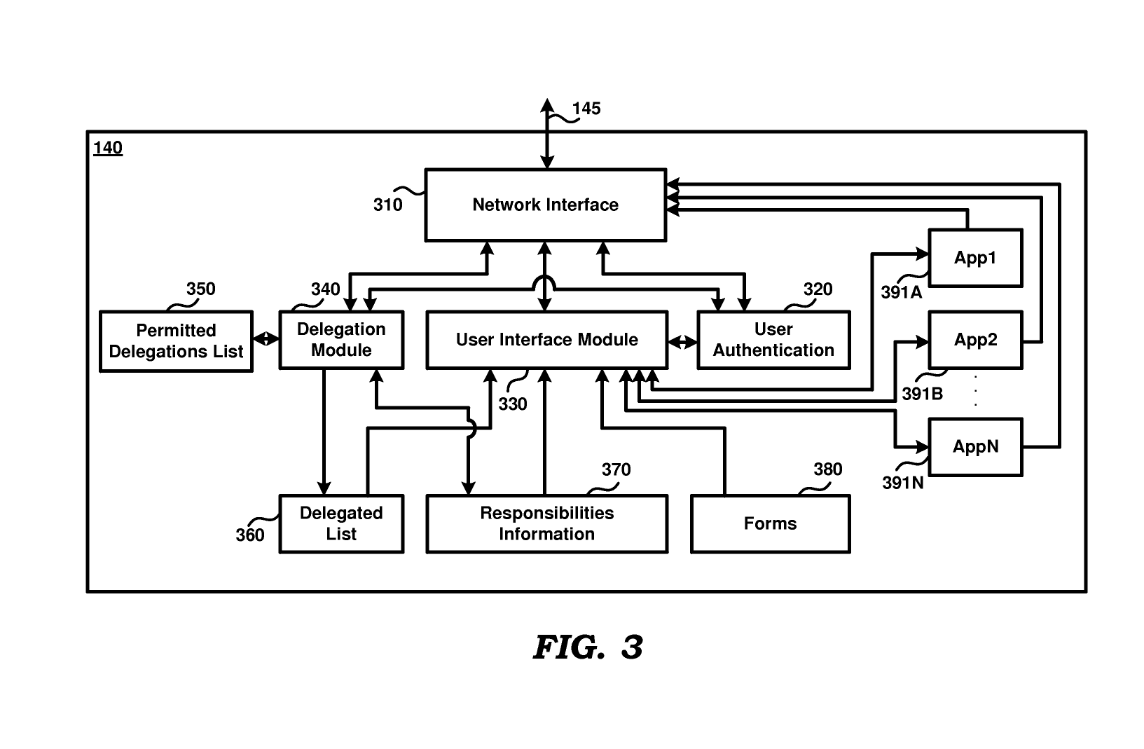

FIG. 3 is a block diagram illustrating the detailed architecture of ERP system 140 in an embodiment. The block diagram is shown containing network interface 310, user authentication block 320, user interface module 330, delegation module 340, permitted delegations list 350, delegated list 360, responsibilities information 370, forms 380, and apps 391A-391N. Each of the blocks may be implemented as a desired combination of hardware, software and firmware, and is described in detail below.

Network interface 310 represents a communication interface (e.g., an Ethernet card) to enable various blocks of ERP server 140 to communicate via network path 145. In general, packets directed to ERP server 140 are examined for forwarding to appropriate internal block. Similarly, network interface 310 sends packets directed to other external systems shown in FIG. 1 upon receipt of the corresponding packets, with identity of the target system, from the respective block.

Each of applications 391A-391N is designed to process user requests and provide corresponding responses. Each of applications 391A-391N may correspond to a module in an ERP system such as human resources management, product planning, marketing/sales, inventory management, shipping/payment, etc. To process such user requests, applications 391A-391N may be configured to store/retrieve data in/from data store 150, and utilize data in data store 150 to generate the responses. An example of processing a user request may be to process the order information entered by the user on an order form.

User authentication module 320 authenticates the user of a user system (e.g., user system 110A) to the ERP server 140. To do so, user authentication module 320 receives authentication information from a user (e.g., an administrator, a delegator, or a delegatee) from the user system 110A and provides access to the respective user interface module 330 or delegation module 340 as a result of authenticating the user based on the authentication information. The authentication information may be embodied as any type of data required by the ERP server 140 to authenticate the user such as, for example, a username and associated password.

Delegation module 340 enables an administrator (who has been authenticated via user authentication module 320) to specify specific tasks that may be delegated, and the class of delegatees to whom tasks may be delegated. For example, an administrator may view all the tasks contained in the system 140 and select a set of tasks that may be delegatable. The administrator may decide that certain critical/secure tasks associated with a CEO are not delegatable and therefore chooses to not select those tasks to further delegate. On the contrary, the administrator may decide that the tasks of the CEO's assistant may be delegatable and chooses to select the corresponding tasks to further delegate. The administrator may also choose to select a class of users to whom tasks may be delegated to. Delegation module 340 also enables a delegator to requests a task(s) to be delegated to a delegatee.

Permitted delegations list 350 contains the specific tasks that are selected by the administrator in delegation module 340 as being delegatable. Permitted delegations list 350 also contains the corresponding class of users selected by the administrator in delegation module 340 as personnel to whom each of the delegatable tasks may be delegated to.

Delegated list 360 maintains the combination of the delegator, the delegatee, and the specific tasks that are delegated to the delegatee. As described previously with reference to FIG. 2A, a delegator logs in to ERP server 140 (via user authentication module 320) and requests a task(s) to be delegated to a delegatee via the delegation module 340. Delegation module 340 determines whether the request is consistent with the permitted delegations list 350, and if so, would add the delegator, delegatee, and the task(s) combination to the delegated list 360. For example, a manager may wish to delegate the task of approving invoices to an assistant. Here, the delegated list 360 would maintain identity of the manager, the task of approving invoices, and the identity of the assistant, as long as the particular combination is permitted by the permitted delegations list 350.

Forms 380 provide the basis for user interactions with ERP server 140. Specifically, forms 380 provide for the set of interactions (“form definition”) with each of the applications 391A-391N. For example, application 391A may contain a set of tasks with each task providing one or more user interactions. A form provides the user with a set of user interactions that assist in performing each of such tasks. Therefore, forms 380 may be viewed as containing any user interface where a user may provide inputs related to a task in connection with a task or where a user may view information related to a certain task.

Responsibilities information 370 contains all responsibilities related to the various applications 391A-391N, and the various responsibilities that are assigned to users of ERP system 140. As noted above, organizational personnel are required to perform several tasks for effective operation of the organization. The tasks (e.g., the task of approving invoices, managing purchase data, etc.) may be grouped together to form a responsibility. For example, a systems administrator may be responsible for several tasks such as user management, review of system errors etc. The tasks are grouped together under the responsibility ‘systems administrator’.

Responsibilities information 370 contains the all responsibilities that make up the entire/full set of responsibilities associated with applications 391A-391N. Additionally responsibilities information 370 contains the responsibilities that are assigned to a user, i.e., the collection of tasks assigned to a user (or the user is responsible for). For each user accessing the ERP sever 140, responsibilities information 370 stores the list of responsibilities (containing the set of tasks) that are either actively assigned to the user or have been assigned to the user (inactive) sometime in the past.

When a new responsibility is added to ERP server 140, typically by associating it with an application 391A-391N, or a component of such application, the new responsibility may be made available to the administrator in an unassigned state, so that the administrator may specify which user(s) have the new responsibility added to their existing set of responsibilities. Additionally, the new responsibility may also be made available to the administrator so that the administrator may specify whether the new responsibility is delegatable. Further, if the new responsibility is marked as delegatable, the new responsibility may also be made available to any delegator who wishes to delegate the new responsibility to a delegatee. Therefore, by extension of the software design implemented in ERP server 140, the new responsibility is automatically/immediately available for delegation.

User interface module 330 controls the user interactions of various users with applications 391A-391N based on respective forms 380. User interface module 330 relies on user authentication block 320 for authentication of each user, and identifies the specific responsibilities of the user based on responsibilities information 370. User interface module 330 also facilitates association of forms (in forms 380) with corresponding responsibilities (and authenticated users) via examining data maintained in responsibilities information 390 and delegated list 360. In an embodiment, users use forms 380 to submit data and the data is passed on to applications 391A-391N by way of form definitions, which contains information on which of the applications 391A-391N, the data is directed to.

In operation, an administrator may login to the ERP server 140 by authenticating via the user authentication block 320. Thereafter, the administrator may select specific responsibilities (i.e., set of tasks) as being delegatable. The administrator may also select a class of users to whom the delegatable responsibilities may be delegated to. The responsibilities and class of users information is stored in permitted delegations list 350.

A user may login to the ERP server 140 by authenticating via user authentication block 320. User interface module 330 thereafter examines the responsibilities information 370 to determine which responsibilities are assigned to the user. Next, user interface module 330 examines forms 380 to retrieve only those forms that are related to the tasks contained in the user's assigned responsibilities. The appropriate forms are passed on to the app 391A-391N in order to be viewed by the user. The user may then interact with the presented forms and take any further action as necessary. The user may also request to delegate a specific task to a delegatee, in which case, the permitted delegations list 350 is examined to verify whether the delegation request is consistent with the permitted delegations in the permitted delegations list 350. If the request is consistent, then the delegation is permitted and the combination of the delegator, the delegate, and the specific tasks that are delegated to the delegatee are stored in the delegated list 360.

The manner in which user interfaces are provided to implement the features of FIG. 2A and FIG. 2B is illustrated below with examples.

### 5. User Interfaces—Administrator

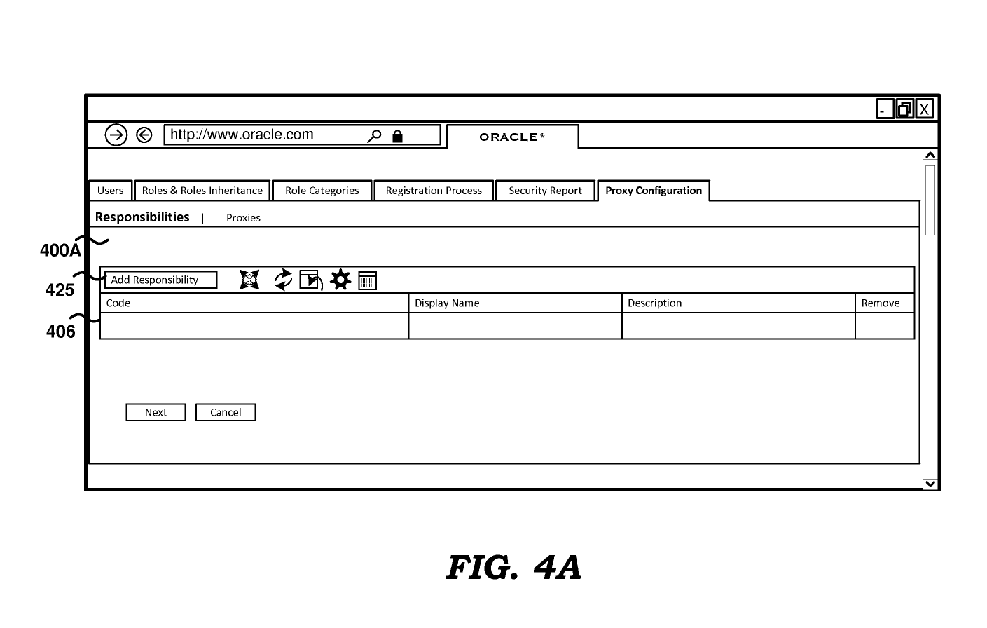

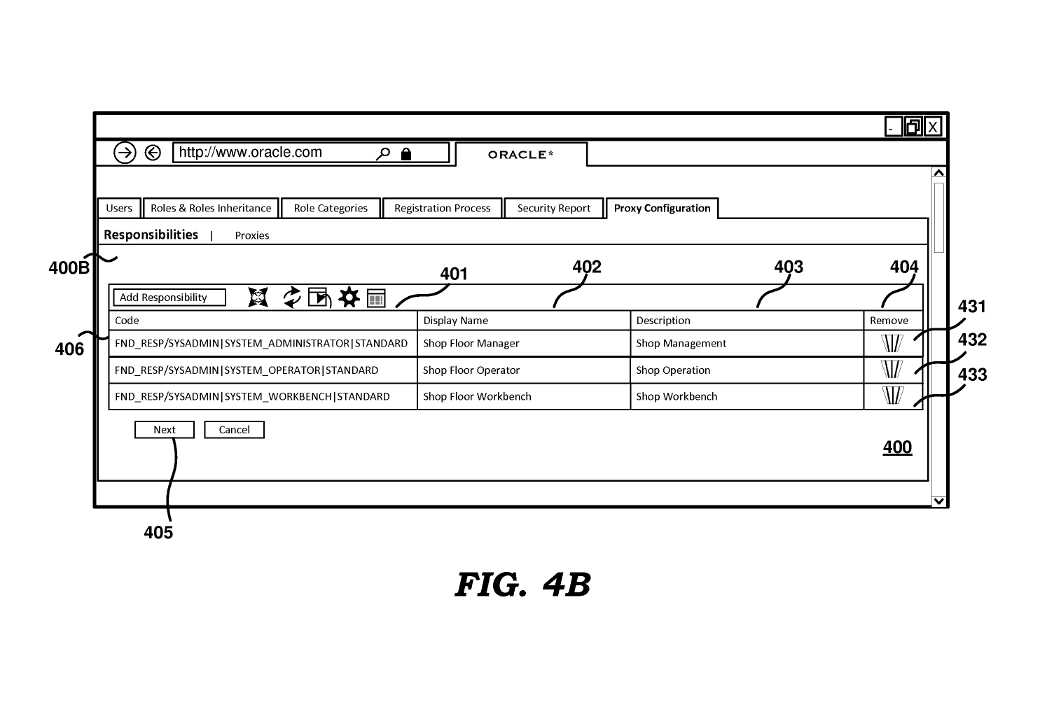

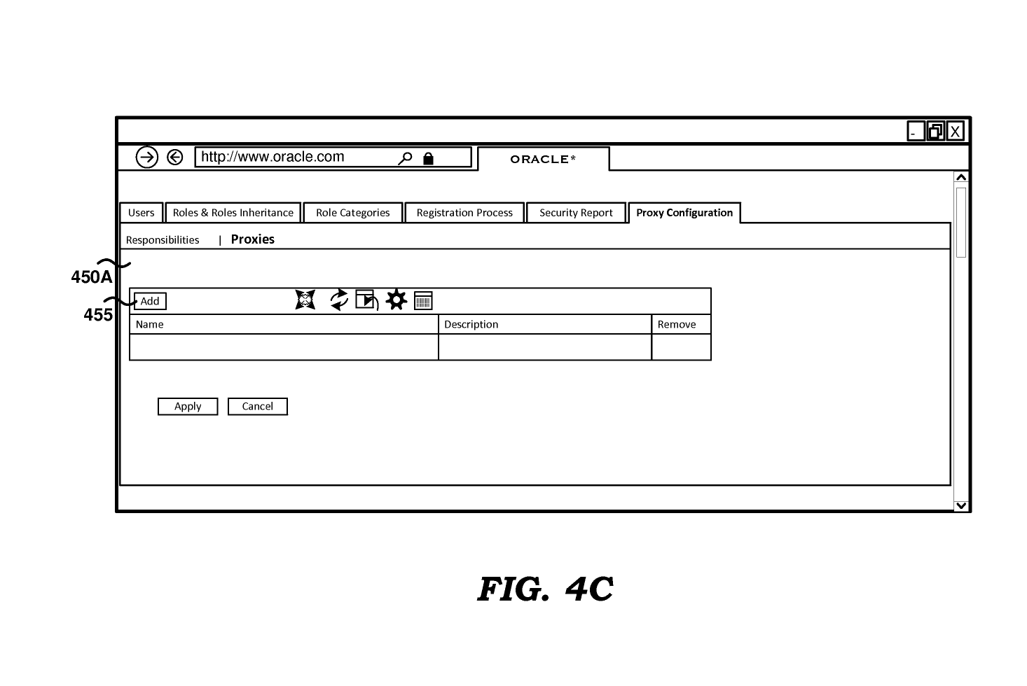

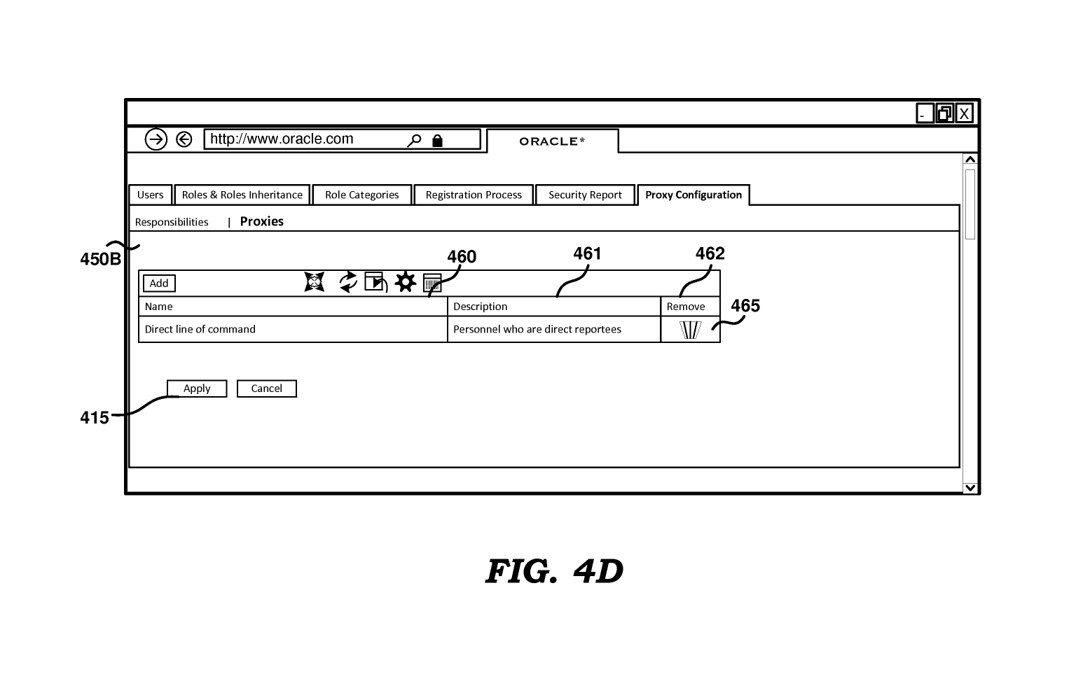

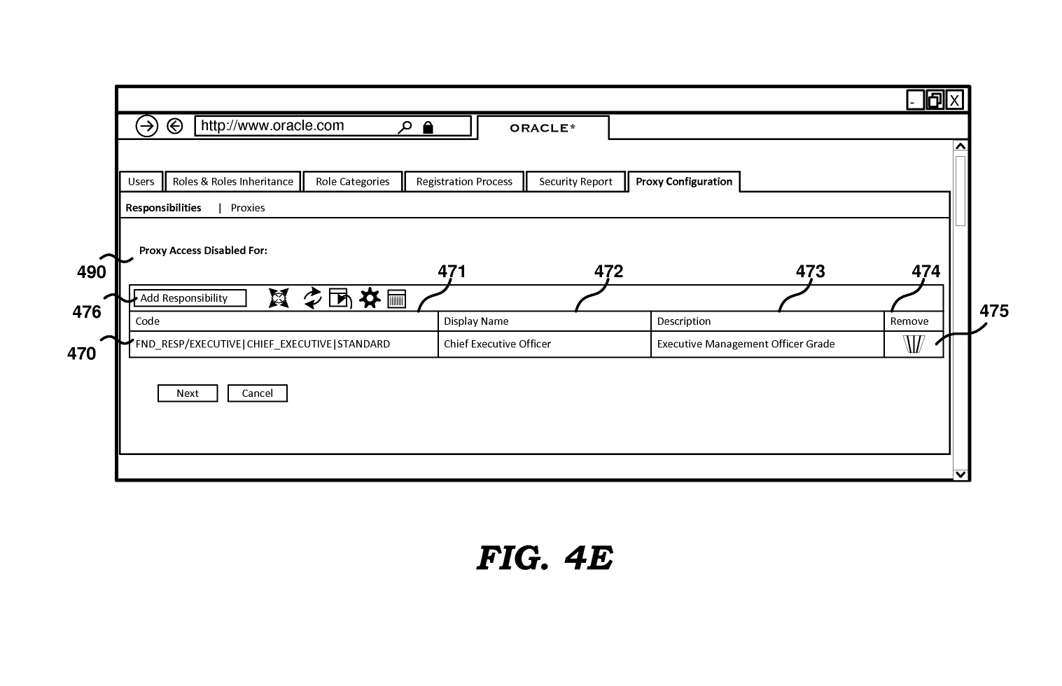

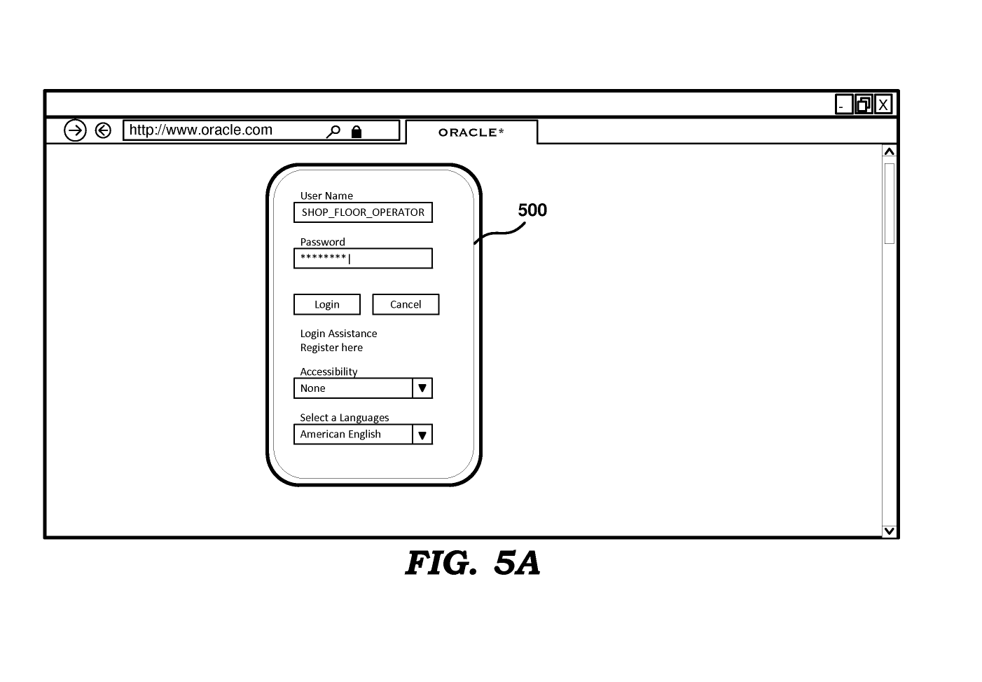

FIGS. 4A-4E depict various user interfaces that may be provided for an administrator to specify specific tasks that may be delegated along with the class of delegatees to whom the tasks may be delegated, according to an aspect of the present disclosure. Each Figure depicts a portion of a user interface (display area 400) provided on a display unit associated with user system 110A.

In one embodiment, display area 400A corresponds to a web page rendered by a browser executing on user system 110A. Web pages are provided in response to the administrator sending appropriate requests (for example, by specifying corresponding URLs in the address bar) using the browser.

FIG. 4A depicts the user interface provided to enable the administrator to view/add responsibilities that may be delegated, with each such responsibility hereinafter referred to as a ‘delegatable responsibility’. As noted above, several tasks may be grouped together as a responsibility. For example, a systems administrator may be responsible for several tasks such as user management, systems management, error review etc. Such tasks may be grouped together as one or more responsibilities.

Display screen 400A shows a delegatable responsibility table 406, which is used to list previously assigned delegatable responsibilities. As shown, no responsibilities have previously been marked as permissible for delegation. The administrator can add new delegatable responsibilities by selecting the add responsibility 425 button.

FIG. 4B shows an updated display screen 400B after the administrator adds three delegatable responsibilities. Columns 401-404 in delegatable responsibility table 406 show additional details of each of the delegatable responsibilities. Column 401 shows the system code that identifies the delegatable responsibility. Column 402 shows the display name of the delegatable responsibility as it appears within the apps (i.e., apps 391A-391N) or within other blocks of ERP server 140. Column 403 shows the description of the responsibility, and column 404 provides the administrator the ability to delete the responsibility from the list of delegatable responsibilities.

Rows 431-433 shows newly added instances of delegatable responsibilities, Shop Floor Manager, Shop Floor Operator and Shop Floor Workbench. After adding the delegatable responsibilities, the administrator may then add the potential class of delegatees by selecting the next icon 405. In alternative embodiments, tasks may be specified for delegation individually, or job titles (or users with specific job titles) may be specified as eligible for delegation in place of specifying individual tasks or responsibilities.

FIG. 4C depicts the user interface provided to enable the administrator to view/add class of delegatees to whom the responsibilities of FIG. 4B are delegated. As noted above, different classes of personnel/users may be selected as being eligible to act as delegatees. For example, direct line of command, second line of command, third line of command, all users, immediate supervisor, and supervisor's supervisor are all possible classes of delegatees. As shown in display screen 450A, no class of delegatees has previously been marked as permissible delegatees. The administrator can add new permissible delegatees by selecting the add 455 button.

FIG. 4D shows an updated display screen 450B after the administrator adds a class of delegatees to whom the delegatable responsibilities may be delegated. Columns 460-462 show additional details of the class of delegatees that have been marked as permissible delegatees. Column 460 shows the name/identity of the class. Column 461 shows the description of the class, and column 463 provides the administrator the ability to delete the class from the list of permissible delegatee classes.

Row 465 shows an instance of a permissible delegatee class, direct line of command, which indicates that users with delegatable responsibilities (as shown in FIG. 4B) may delegate their responsibilities to users/personnel who are their direct reportees. After adding the permissible delegatee class, the administrator may then add the permissible delegatees along with the delegatable responsibilities by selecting the apply icon 415. Upon selecting the apply icon 415, the delegatable responsibilities of FIG. 4B and the class of permissible delegatees of FIG. 4D are added to a permitted delegations list in ERP server 140, as previously described with reference to FIG. 2A. A user interface similar to FIGS. 4C-4D can be provided to specify the specific class of delegators who can/cannot delegate the tasks specified in FIG. 4B.

FIG. 4E depicts an alternate user interface provided to enable the administrator to view/add responsibilities that may not be delegated, with each such responsibility hereinafter referred to as a ‘non-delegatable responsibility’. Display screen 490 shows a non-delegatable responsibility table 470, which is used to list previously-assigned non-delegatable responsibilities.

Columns 471-474 in non-delegatable responsibility table 470 show additional details of each of the non-delegatable responsibilities. Column 471 shows the system code that identifies the non-delegatable responsibility. Column 472 shows the display name of the non-delegatable responsibility as it appears within the apps (i.e., apps 391A-391N) or within other blocks of ERP server 140. Column 473 shows the description of the responsibility, and column 474 provides the administrator the ability to delete the responsibility from the list of non-delegatable responsibilities.

Row 475 shows the previously added instance of non-delegatable responsibility, Chief Executive Officer. The administrator can add new non-delegatable responsibilities by selecting the add responsibility 476 button, as will be apparent to one skilled in the relevant arts by reading the disclosure herein.

The description is continued with respect to user interfaces provided to the delegator and delegatee.

### 6. User Interfaces—Delegator and Delegatee

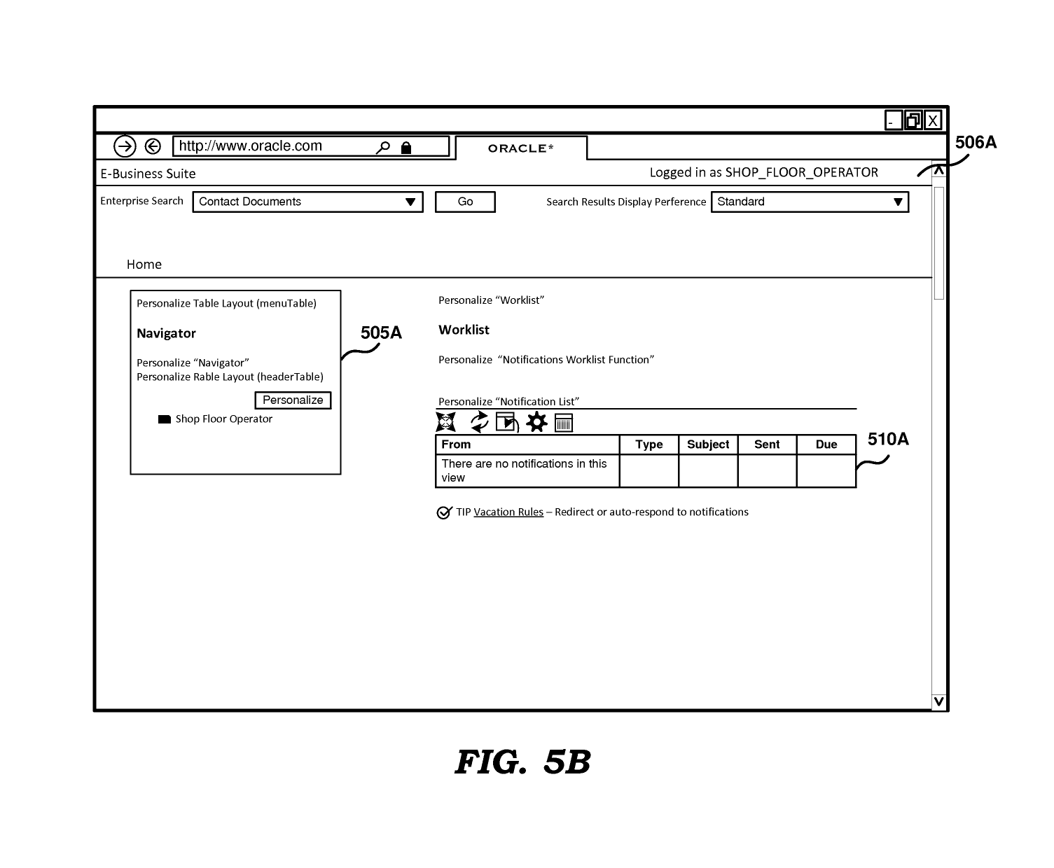

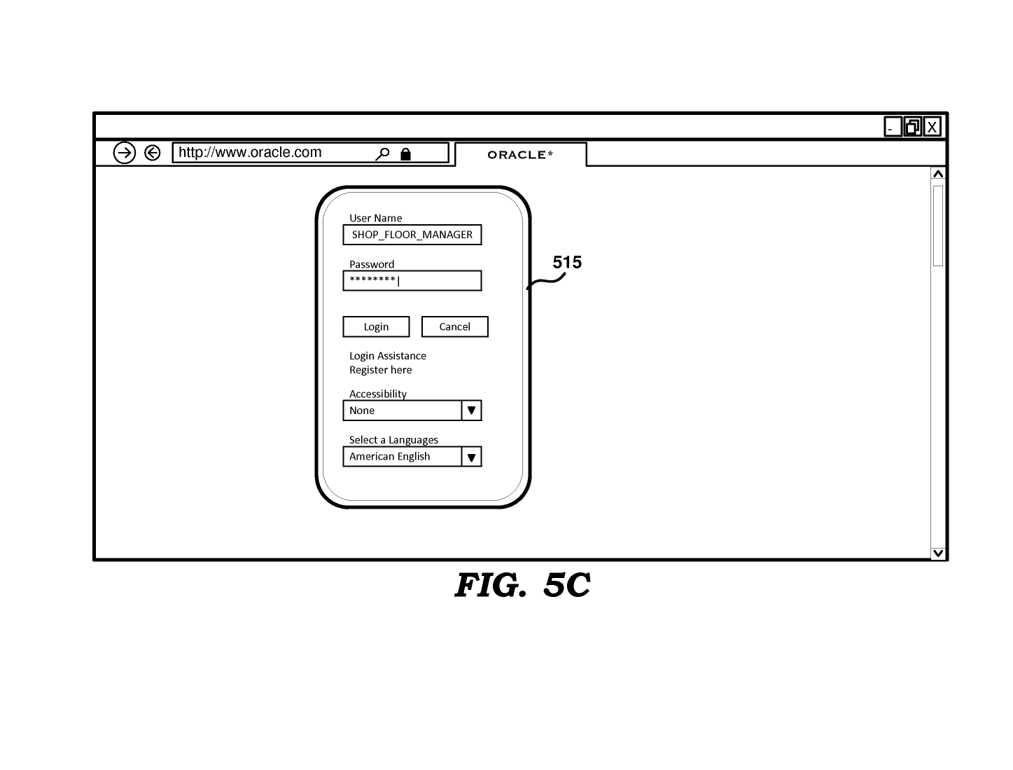

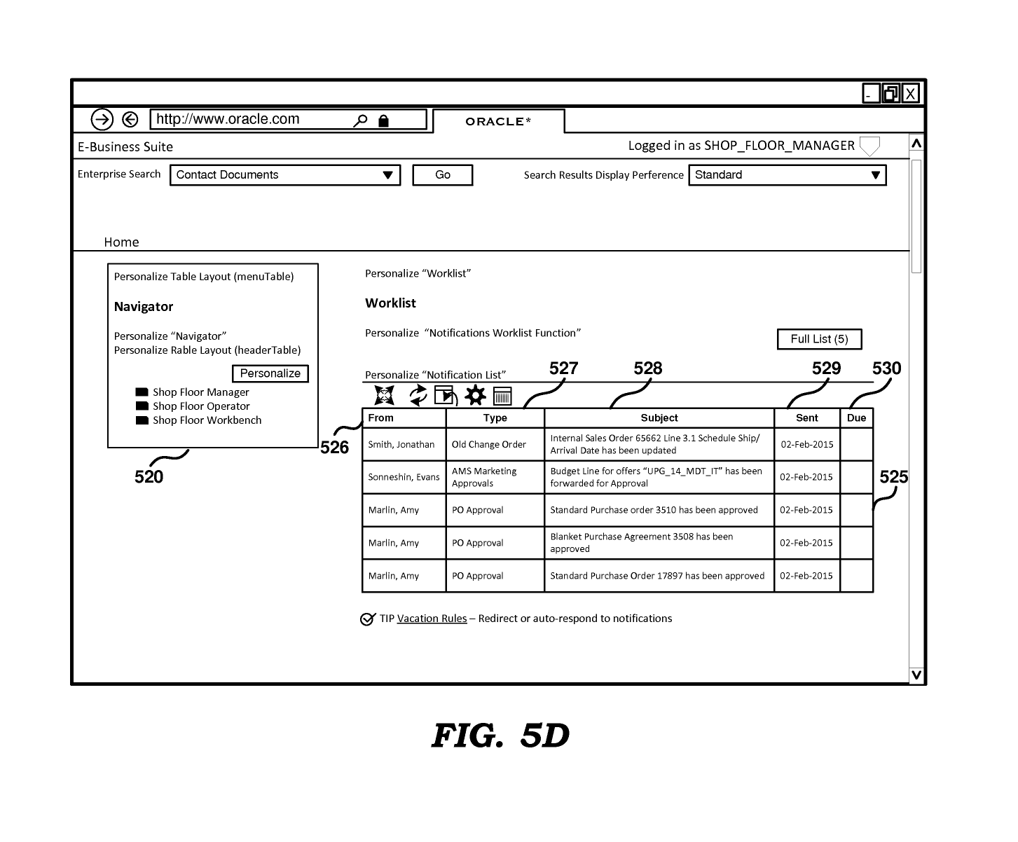

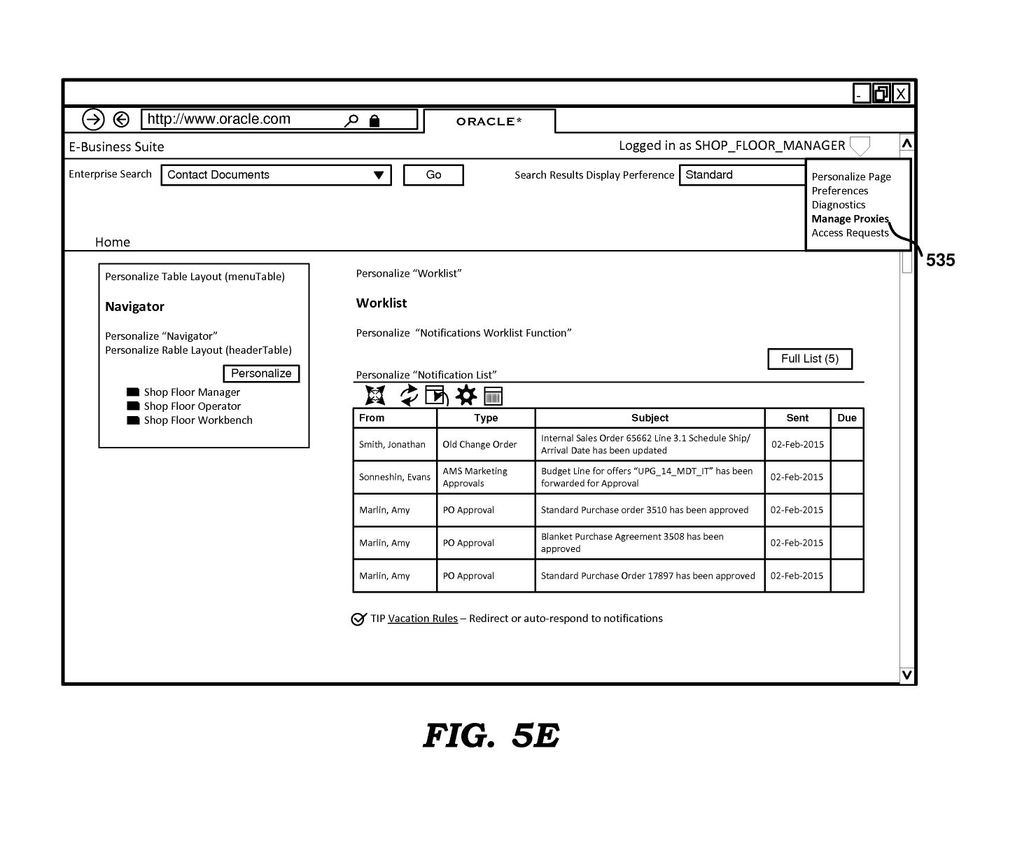

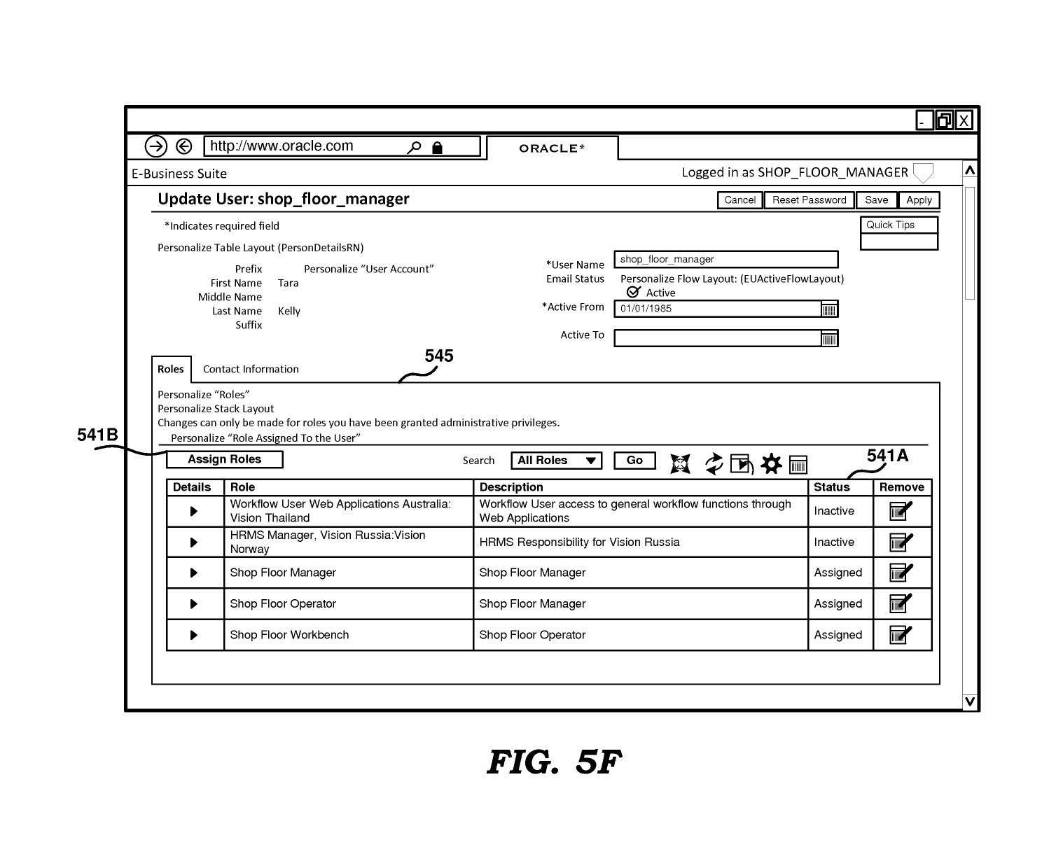

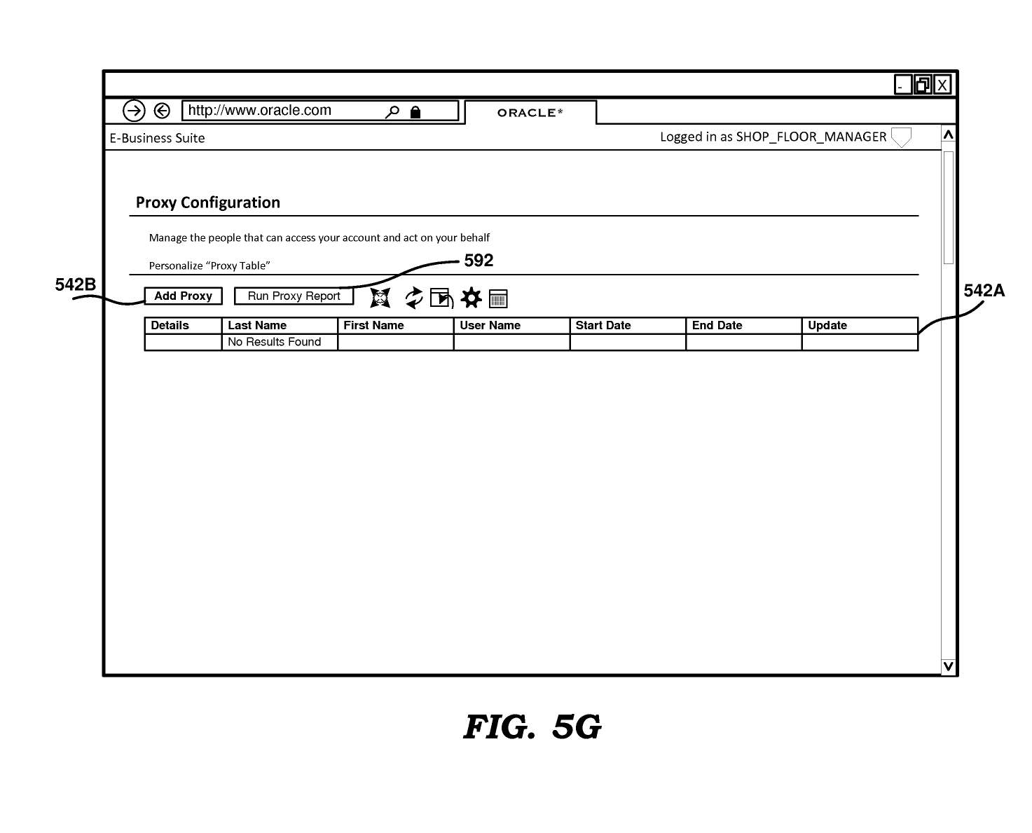

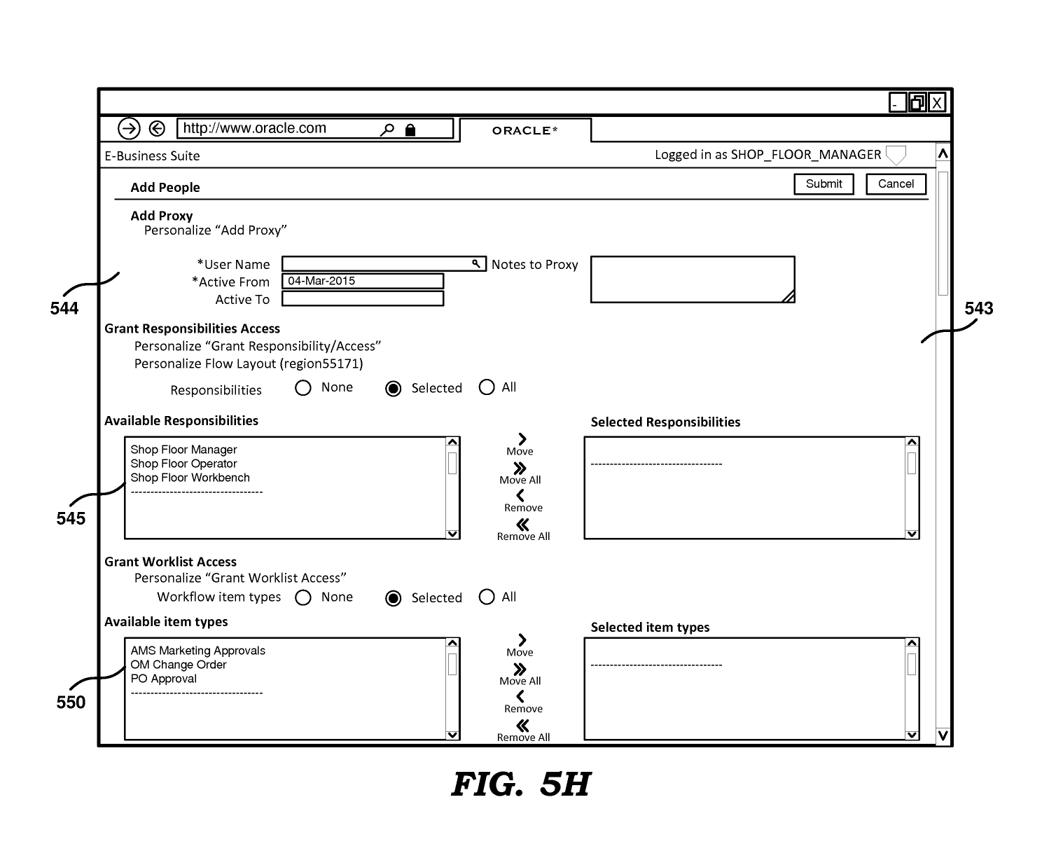

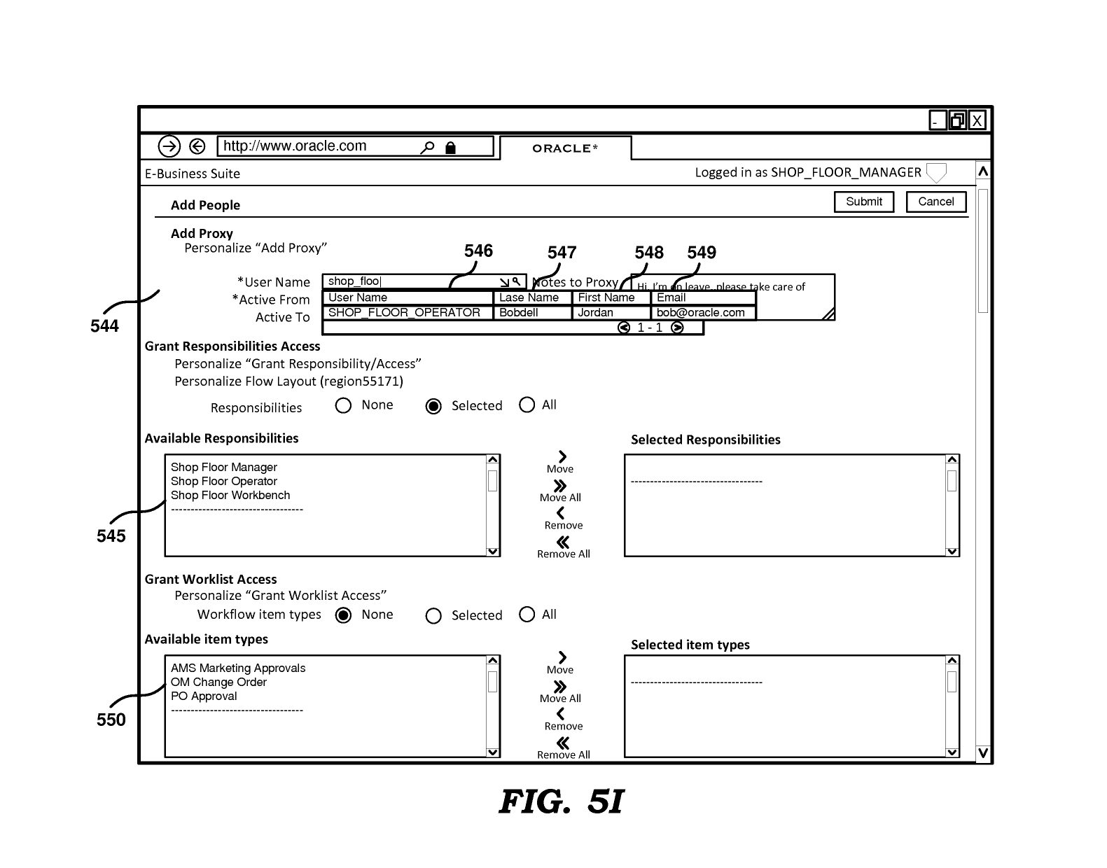

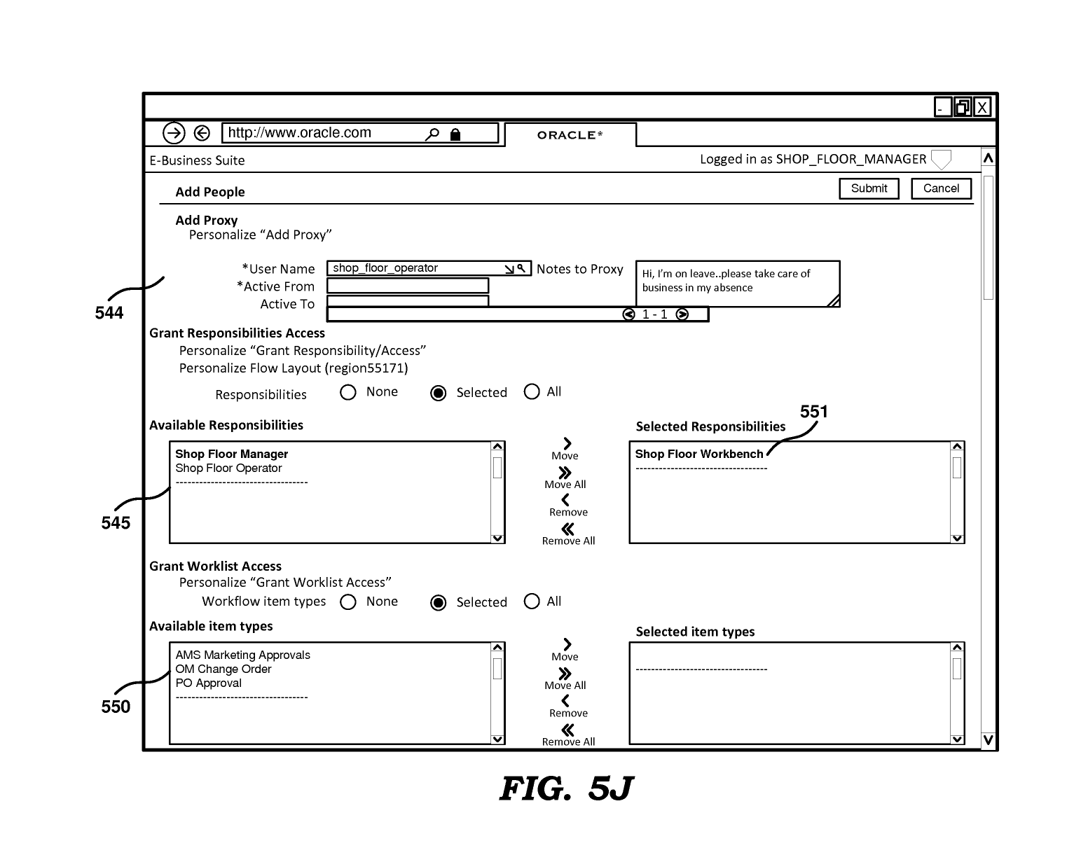

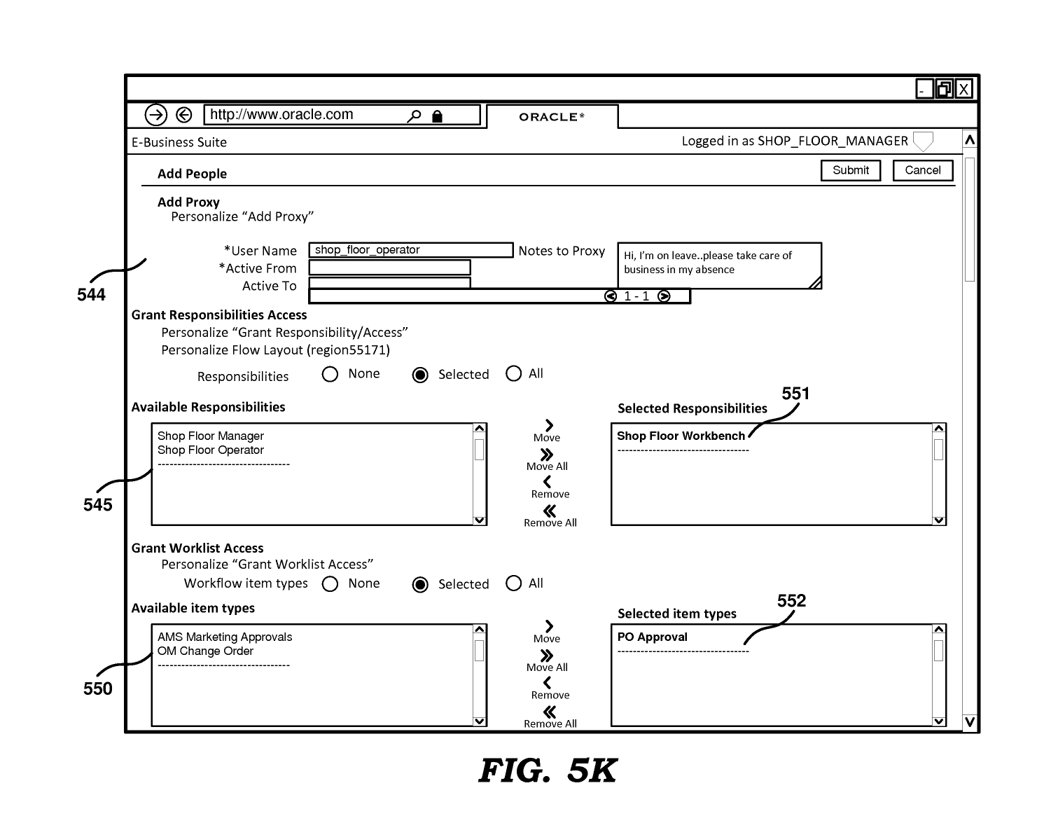

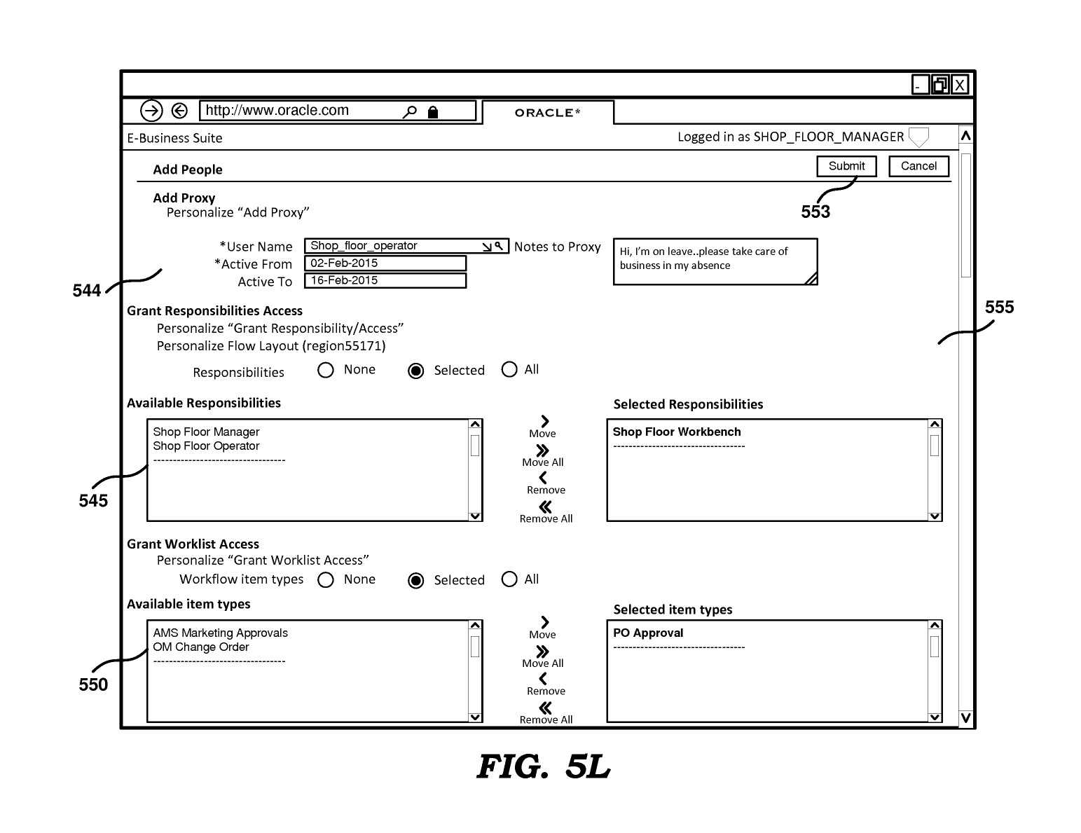

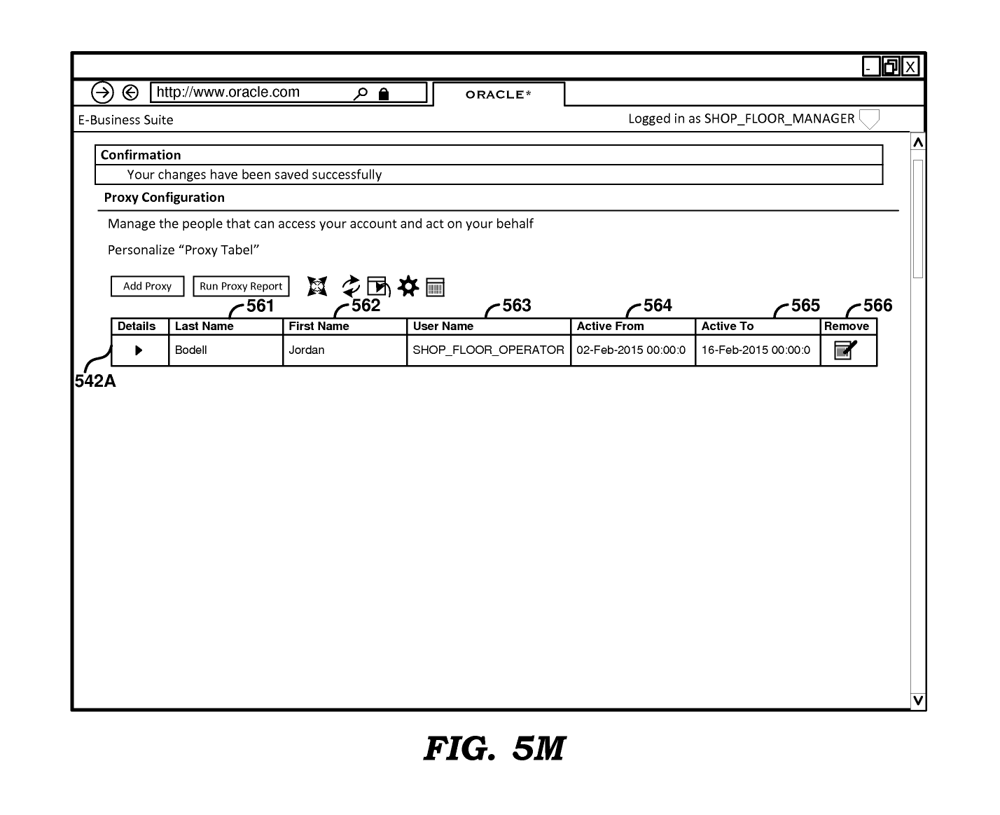

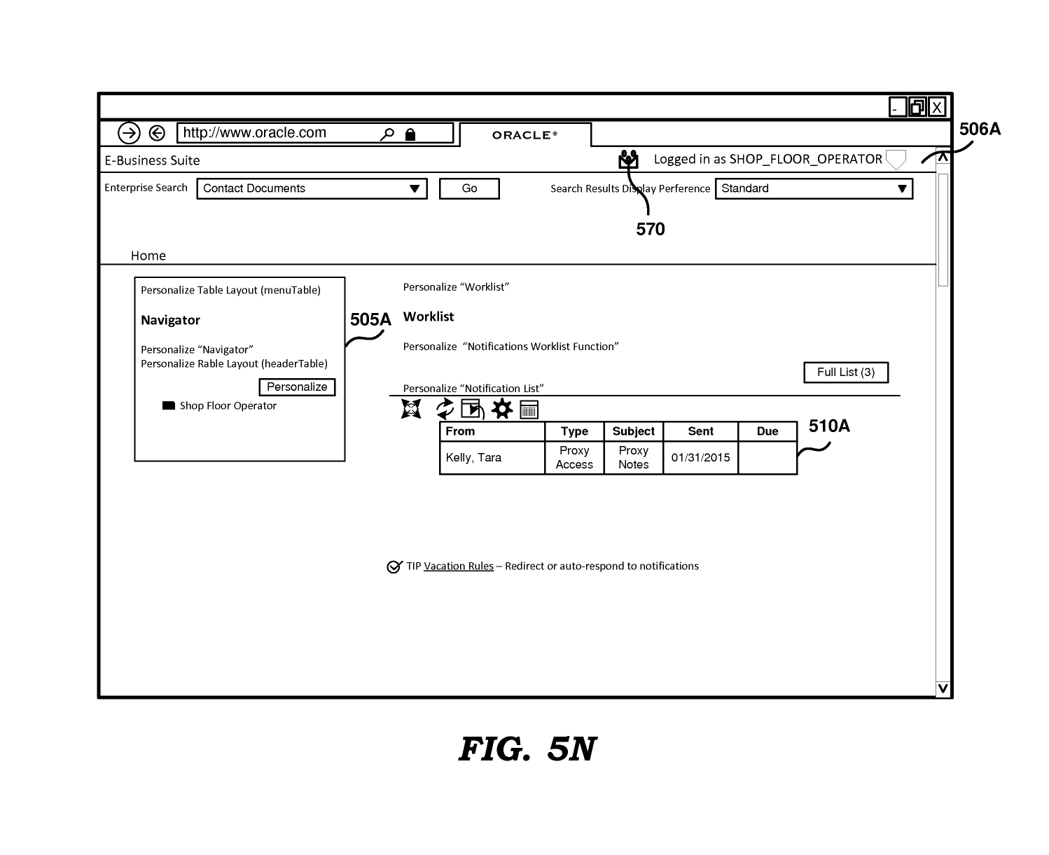

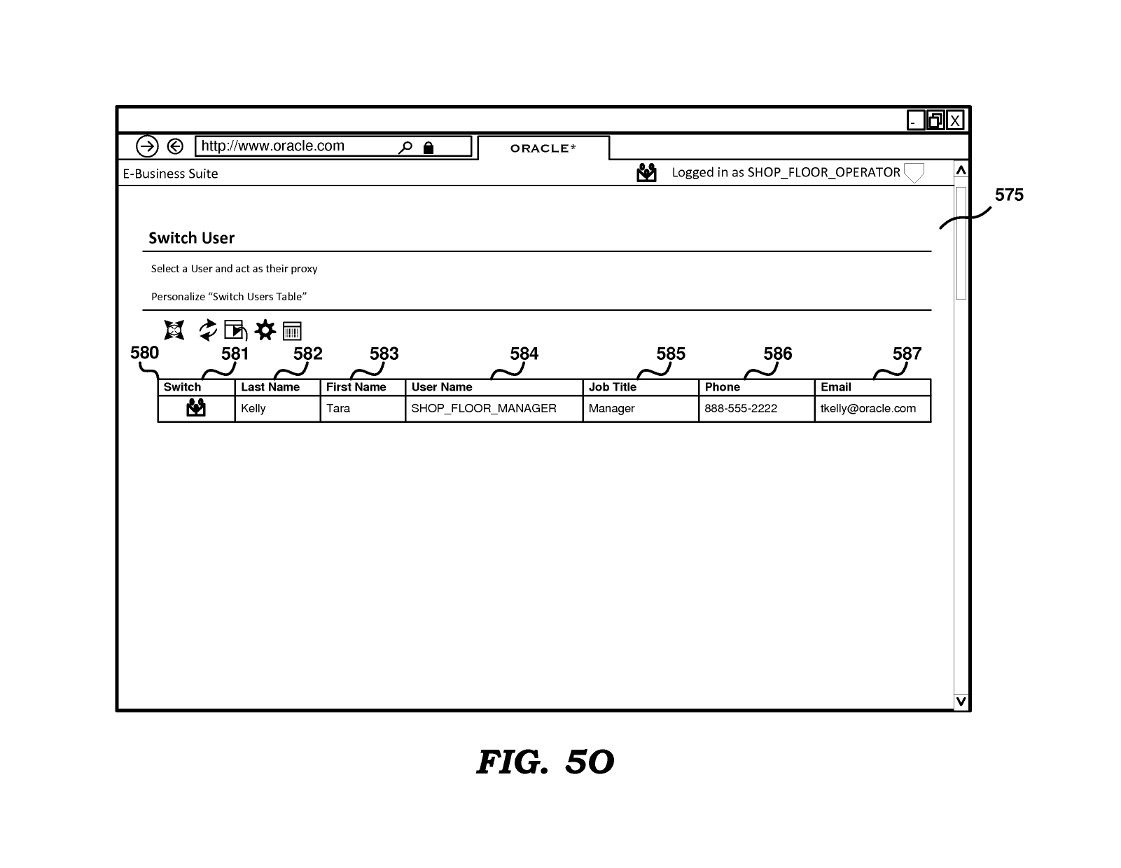

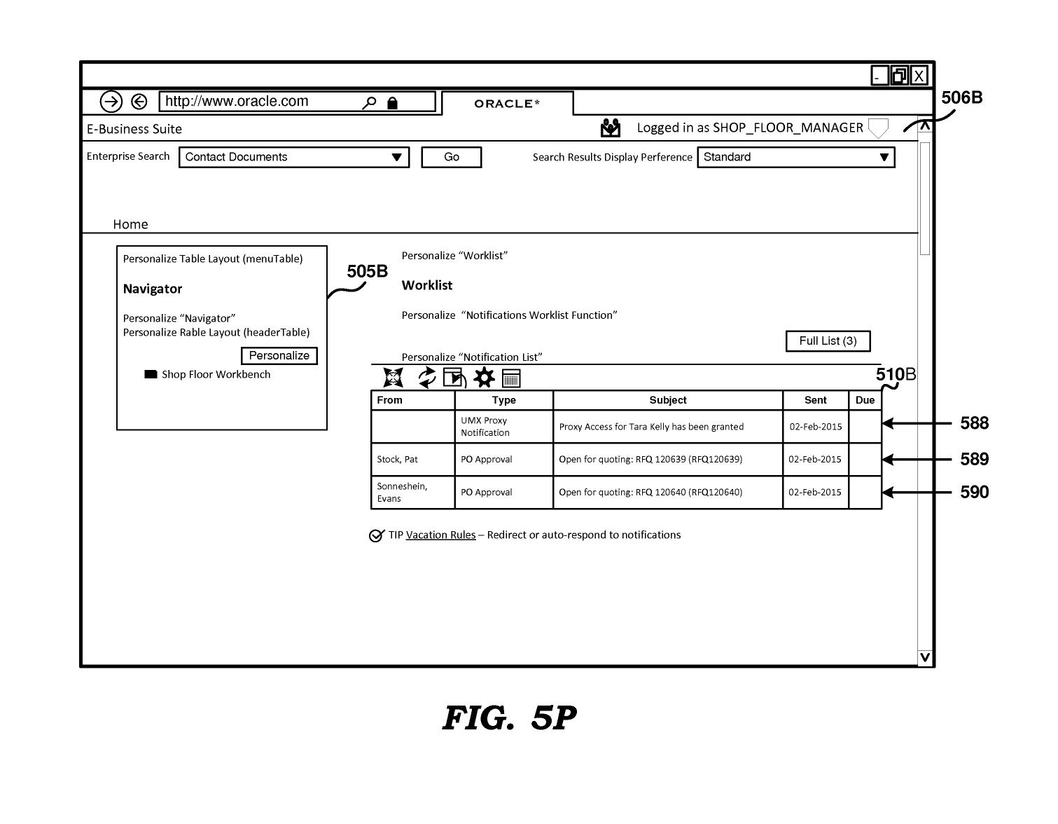

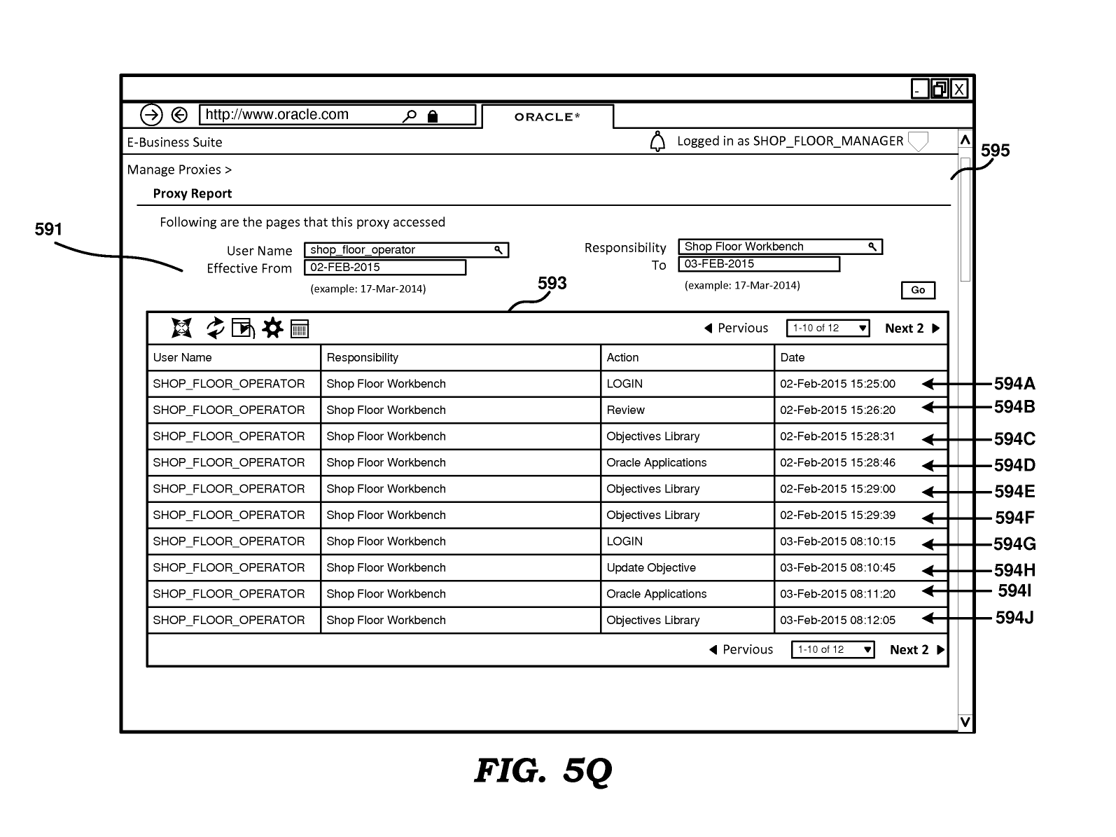

FIGS. 5A-5Q depict various user interfaces that may be provided for a delegator to delegate responsibilities to a delegatee, and for a delegatee to view the delegated responsibilities, according to an aspect of the present disclosure. Each Figure depicts a portion of a user interface provided on a display unit associated with user system 110A.

FIG. 5A depicts the user interface provided to a prospective delegatee in a typical web browser. Display area 500 indicates that the prospective delegatee has selected to login to their account home page by entering appropriate login information. Hereinafter, the prospective delegatee will be referred to as a shop_floor_operator.

FIG. 5B depicts the shop_floor_operator's account home page. Display area 506A shows the shop_floor_operator as the user logged into the home page. Display area 505A shows the various responsibilities that are assigned to the shop_floor_operator. Display area 510A shows the various worklist notifications that are available to the shop_floor_operator.

Worklists are task instances that are triggered by the actions of another user (e.g., when a email is sent by others or a purchase order is entered for approval). For example, the shop_floor_operator may be part of a group of users who receive daily quality reports from a quality operator. Such reports (i.e., task instances) would appear as worklist notifications in the display area 510A. In this example, the task of the shop_floor_operator may be to review the quality reports to check for accuracy and consistency. In other examples, such as approval of purchase orders, the shop_floor_operator may be required to take an affirmative action to complete the task instance by approving/rejecting the purchase order.

FIG. 5C depicts the user interface provided to a prospective delegator in a typical web browser. Display area 515 indicates that the prospective delegator has selected to login to their account home page by entering appropriate login information. Hereinafter, the prospective delegator will be referred to as a shop_floor_manager.

FIG. 5D depicts the shop_floor_manager's account home page. Display area 520 shows the various responsibilities that are assigned to the shop_floor_manager. Specifically, display area 520 shows that the shop_floor_manager has responsibilities of a shop floor manager, a shop floor operator, and a shop floor workbench.

Display area 525 shows the various worklist notifications that are available to the shop_floor_manager. Columns 526-530 show additional details of the worklist notifications. Column 526 shows the identity of the other user whose actions triggered the worklist notification (e.g., Smith, Jonathan). Column 527 shows the type of worklist notification being displayed (e.g., PO approval, old change order, etc.). Column 528 shows the subject of the notification. Column 529 shows the date the notification was sent, and column 530 shows any due dates associated with the displayed notification.

FIG. 5E shows the shop_floor_manager initiating the process of assigning a delegatee by selecting the manage proxies link 535 from a list of options available to the shop_floor_manager.

FIG. 5F shows the first screen among a sequence of screens provided to shop_floor_manager in the process of assigning the delegatee to one or more responsibilities. Display area 540 shows several responsibilities assigned to the shop_floor_manager, including both active and inactive responsibilities. For example, a user may have multiple responsibilities assigned to them over the course of their career, but may only be actively responsible for a smaller sub-set of the full set of responsibilities ever assigned to them. In such a case, the responsibilities shown in display area 540 indicate the inactive/active status as corresponding to previously-assigned-but-not-active, and presently-active responsibilities respectively. As shown in column 541A, shop_floor_manager has three active responsibilities, while maintaining two inactive responsibilities. The shop_floor_manager may click on assign roles link 541B to view existing delegatees.

FIG. 5G shows the web page provided to shop_floor_manager when the shop_floor_manager selects assign roles link 541B in FIG. 5F. Display area 542A shows any existing delegatees assigned by shop_floor_manager. Shop_floor_manager may also choose to review actions taken by existing delegatees by selecting run proxy report 592 icon. As shown in display area 542A, user shop_floor_manager currently does not have any existing delegatees assigned. Shop_floor_manager may select the add proxy link 542B to select individual delegatees to assign responsibilities to.

FIG. 5H shows the screen displayed to shop_floor_manager upon selection of the add proxy link 542B in FIG. 5G. Display screen 543 shows the screen divided into various sections 544, 545, and 550. Section 544 shows the fields available for shop_floor_manager to identify the delegatee (user name), the period of delegator-delegatee relationship (active from, active to), and to specify any notes to be communicated to the delegatee regarding the delegator-delegatee relationship (notes to proxy). Section 545 shows the list of active responsibilities for shop_floor_manager that are available to be delegated (i.e., delegatable responsibilities). Section 550 shows additional delegatable responsibilities in the form of worklists.

The list of delegatable responsibilities is dynamic. Specifically, if an enterprise application (or a component of the enterprise application) is extended with new responsibilities (i.e., one or more tasks), or if inactive responsibilities in the enterprise application (or a component of the enterprise application) are activated, such responsibilities/tasks are automatically available to the administrator in order for the administrator to specify whether any of the new responsibilities/tasks can be delegated. Further, any of the new responsibilities/tasks that are specified by the administrator as being eligible for delegation are thereafter automatically available for the delegator (e.g., shop_floor_manager) to delegate. Automatic implies that new (or newly activated) responsibilities/tasks are placed in the responsibilities information 370 shown in FIG. 3, and once they are placed in the responsibilities information 370, they are available for the administrator to control as a delegatable responsibility (via delegation module 340 of FIG. 3), and available for the delegator to delegate to a delegatee (via delegation module 340 of FIG. 3).

For example, if a new responsibility ‘trainer’ is added to the enterprise application 391A-391N, the new responsibility would appear as part of FIGS. 4A-4B for the administrator to assign as a delegatable responsibility, and in section 545 for the shop_floor_manager to be able to delegate such responsibility to a delegatee. Similarly, any responsibilities removed from the enterprise application would cease to appear in section 545.

FIG. 5I shows shop_floor_manager entering a string containing the identifying information of the delegatee. As shown in section 544, in response to the user entering the string, a drop-down list of all users matching the input string is shown. In the example shown in FIG. 5I, column 546 shows the matching user name as shop_floor_operator, column 547 shows the last name associated with the user shown in column 546 (Bobdell), column 548 shows the first name associated with the user shown in column 546 (Jordan), and column 549 shows the email address associated with the user shown in column 546.

FIG. 5J shows that the shop_floor_manager has selected to delegate a responsibility Shop Floor Workbench, as shown in display area 551. FIG. 5K shows that the shop_floor_manager has selected to delegate a worklist task PO Approval, as shown in display area 552.

FIG. 5L shows a summary screen 555 that indicates that the shop_floor_manager has chosen to delegate the selected responsibility shop floor workbench and worklist item type PO approval to the delegatee shop_floor_operator from a period of 2 Feb. 2015 to 16 Feb. 2015. Shop_floor_manager then proceeds to assign the delegatable responsibilities to shop_floor_operator by selecting the submit button 553. Upon selecting the submit button 533, the delegatable responsibilities (shop_floor_workbench, and PO approval), the delegator (shop_floor_manager), and the delegatee (shop_floor_operator) are added to a delegated list in ERP server 140, as previously described with reference to FIGS. 2A and 3.

FIG. 5M shows the list of delegatees for shop_floor_manager, after the shop_floor_manager selects the submit button 553 in FIG. 5L. Display area 542A lists the updated delegator-delegatee relationships for the user shop_floor_manager. Columns 561-566 show details of the delegatee.

Column 561 shows last name of the delegatee (Bobdell), column 562 shows the first name of the delegatee (Jordan), column 563 shows the username/identity of the delegatee (shop_floor_operator), column 564 shows the starting date of the delegator-delegatee relationship, column 565 shows the end date of the relationship, and column 566 provides the shop_floor_manager with the ability to delete the delegator-delegatee relationship between the shop_floor_manager and the shop_floor_operator.

FIG. 5N depicts the shop_floor_operator's account home page, after the shop_floor_operator has been assigned as a delegatee by shop_floor_manager. Display area 506A shows the shop_floor_operator as the user logged into the home page. Display area 505A shows the various responsibilities that are assigned to the shop_floor_operator.

Display area 510A shows the various worklist notifications that are available to the shop_floor_operator. Specifically, display area 510A shows the message sent from the shop_floor_manager Tara Kelly (i.e., message shown previously in section 544 in FIG. 5K) notifying the shop_floor_operator of the newly delegated responsibilities and worklists.

Unlike the shop_floor_operator's home page screen shown in FIG. 5B, FIG. 5N shows a switch user icon 570, which indicates to the shop_floor_operator that the shop_floor_operator is assigned one more responsibilities and worklists as a delegatee. The shop_floor_operator may select the switch user icon 570 to switch to the responsibilities of a delegator.

FIG. 5O depicts the screen presented to the shop_floor_operator upon the shop_floor_operator selecting the switch user icon 570 in FIG. 5N. Proxy table 580 shows additional details of each of the delegations. Column 581 provides shop_floor_operator the ability to switch to the role of the delegator. Column 582 shows the last name and column 583 shows the first name of the user who delegated the responsibilities to the shop_floor_operator. Column 584 shows the display name of the delegator as it appears within the apps (i.e., apps 391A-391N) or within other blocks of ERP server 140. Column 585 shows the job title of the delegator, and columns 586 and 587 provide phone and email address information of the delegator. The shop_floor_operator may choose to switch to the responsibilities of the delegator by choosing the icon in column 581. It should be appreciated that the delegatee is able to switch between proxy and self roles, without having to provide the authentication information of the delegator.

FIG. 5P shows the display screen shown to shop_floor_operator when the shop_floor_operator switches to the responsibilities of the delegator by choosing the switch icon in column 581 of FIG. 5O. As shown in display area 506B, shop_floor_operator's home page is updated to reflect that the shop_floor_operator is currently logged in as shop_floor_manager.

Display area 505B shows the various responsibilities that are assigned to the shop_floor_operator from shop_floor_manager. Specifically, display area 505B shows that the responsibility ‘shop floor workbench’ has been delegated to shop_floor_operator (as also previously shown in FIG. 5J).

Display area 510B shows the various worklist notifications that are available to the shop_floor_operator in their capacity as the shop_floor_manager. Specifically, row 588 shows a notification that the shop_floor_manager received confirming the delegation of responsibilities to shop_floor_operator. Similarly, rows 589 and 590 show worklist notifications available for review and/or approval by the shop_floor_operator. As previously shown in FIG. 5K, shop_floor_manager only delegated the worklist type of ‘PO Approval’ to shop_floor_operator. Therefore, rows 589 and 590 also show only PO Approvals in the worklist notification table.

FIG. 5Q depicts the display screen shown as the shop_floor_manager reviews various delegatee actions. As shown previously in FIG. 5G, the delegator may choose to review actions by selecting a run proxy report 592 icon. Display screen 595 is shown in response to shop_floor_manager selecting the run proxy report 592 icon shown in FIG. 5G. Shop_floor_manager may choose to filter the proxy report to just one delegatee by selecting the various search parameters shown in display area 591.

Display area 591 shows that shop_floor_manager selected to view actions by the delegatee shop_floor_operator for the responsibility shop floor workbench for the period of 2 Feb. 2015 to 3 Feb. 2015. Table 593 shows all actions by the delegatee shop_floor_operator for the selected responsibility and time period. Rows 594A-594J show the various actions taken by shop_floor_operator during that time. For example, row 594A shows that the user with the user name shop_floor_operator, while being assigned the responsibility of ‘shop floor workbench’, took the action of logging in at 15:25:00 on 2 Feb. 2015. As such, the delegator may view all actions by all delegatees in such manner.

It may thus be appreciated that a user may conveniently access and update delegator-delegatee relationships, and enable the delegatee to perform the delegated responsibilities, thereby enabling organizations to control various aspects of delegation of tasks. It should be appreciated that the features described above can be implemented in various embodiments as a desired combination of one or more of hardware, executable modules, and firmware. The description is continued with respect to an embodiment in which various features are operative when executable modules are executed.

### 7. Digital Processing System

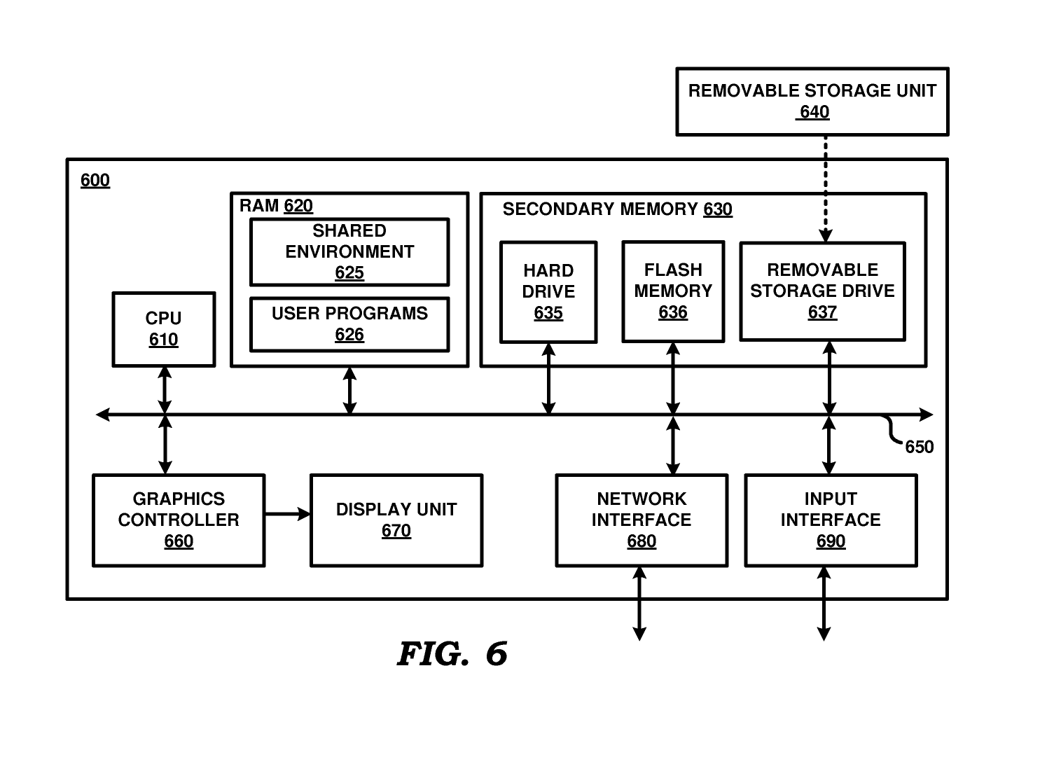

FIG. 6 is a block diagram illustrating the details of digital processing system 600 in which several aspects of the present disclosure are operative by execution of appropriate software instructions. Digital processing system 600 may correspond to ERP server 140 from which various features described above can be provided.

Digital processing system 600 may contain one or more processors (such as a central processing unit (CPU) 610), random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit. RAM 620 may receive instructions from secondary memory 630 using communication path 650.

RAM 620 is shown currently containing software instructions constituting shared environment 625 and/or user programs 626 (such as enterprise applications, etc.). Shared environment 625 contains utilities shared by user programs, and such shared utilities include application servers, operating system, device drivers, virtual machines, flow engines, etc., which provide a (common) run time environment for execution of user programs 626.

Graphics controller 660 generates display signals (e.g., in RGB format) to display unit 670 based on data/instructions received from CPU 610. Display unit 670 contains a display screen to display the images defined by the display signals (such as the portions of the user interfaces of FIGS. 4A-4E). Input interface 690 may correspond to a keyboard and a pointing device (e.g., touch-pad, mouse) that may be used to provide various inputs (such as to specify the desired inputs, etc. in the user interfaces of FIGS. 4A-4E). Network interface 680 provides connectivity to a network (e.g., using Internet Protocol), and may be used to communicate with other systems (such as those shown in FIG. 1) connected to the network.

Secondary memory 630 may contain hard drive 635, flash memory 636, and removable storage drive 637. Secondary memory 630 represents a non-transitory medium, which may store the data (for example, data generated by enterprise applications) and software instructions (for example, for performing the steps of FIGS. 2A and 2B), to enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Secondary memory 630 may contain hard drive 635, flash memory 636, and removable storage drive 637. Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 8. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of delegating tasks in an enterprise application executing on a server system, said method comprising:
receiving from an administrator data specifying a first set of tasks that can be delegated and a class of permissible delegatees to whom said first set of tasks can be delegated;
adding said first set of tasks and said class of delegatees to a permitted delegations list;
receiving a first request from a delegator to delegate a task to a delegatee;
examining said permitted delegations list to determine whether said first request is permitted; and
adding said task and said delegatee to a delegated list if said first request is permitted.

2. The method of claim 1, further comprising:
receiving a second request from a first user to operate as a delegatee for a second user;
examining said delegated list to determine whether said first user is permitted to be a delegatee for said second user; and
enabling said first user to operate as said delegatee for said second user for a first plurality of tasks indicated to be delegated to said first user by said second user in said delegated list.

3. The method of claim 2, wherein said first user is enabled to operate as said delegatee without having to provide said second user's authentication information, said method further comprising permitting said first user to switch between performing a first set of tasks as said second user and a second set of tasks as said first user without said first user being required to authenticate again for said switching.

4. The method of claim 3, further comprising enabling said second user to review actions corresponding to said first set of tasks performed by said first user as said delegatee.

5. The method of claim 4, wherein said examining said permitted delegations list further comprising:
reviewing said permitted delegations list to determine whether said delegatee and said task exist in said permitted delegations list.

6. The method of claim 5, wherein said second user is enabled to specify a subset of a full set of tasks to be delegated to said first user, wherein said full set of tasks represent all tasks enabled to be performed by said second user and delegable by said second user, and said subset of tasks represent a portion of said all tasks,
wherein said subset of tasks correspond to said first plurality of tasks.

7. The method of claim 2, wherein an application component of said enterprise application is extended with a new set of tasks,
wherein said new set of tasks are automatically available to said administrator to specify whether any of said new set of tasks can be delegated, wherein any of said new set of tasks specified as being eligible for delegation are thereafter automatically available for said delegator to delegate.

8. A non-transitory machine readable medium storing one or more sequences of instructions for enabling a server system to support delegation of tasks in an enterprise application, wherein execution of said one or more instructions by one or more processors contained in said server system enables said server system to perform the actions of:
receiving from an administrator data specifying a first set of tasks that can be delegated and a class of permissible delegatees to whom said first set of tasks can be delegated;
adding said first set of tasks and said class of delegatees to a permitted delegations list;
receiving a first request from a delegator to delegate a task to a delegatee;
examining said permitted delegations list to determine whether said first request is permitted; and
adding said task and said delegatee to a delegated list if said first request is permitted.

9. The non-transitory machine readable medium of claim 8, further comprising:
receiving a second request from a first user to operate as a delegatee for a second user;
examining said delegated list to determine whether said first user is permitted to be a delegatee for said second user; and
enabling said first user to operate as said delegatee for said second user for a first plurality of tasks indicated to be delegated to said first user by said second user in said delegated list.

10. The non-transitory machine readable medium of claim 9, wherein said first user is enabled to operate as said delegatee without having to provide said second user's authentication information, said method further comprising permitting said first user to switch between performing a first set of tasks as said second user and a second set of tasks as said first user without said first user being required to authenticate again for said switching.

11. The non-transitory machine readable medium of claim 10, further comprising enabling said second user to review actions corresponding to said first set of tasks performed by said first user as said delegatee.

12. The non-transitory machine readable medium of claim 11, wherein said examining said permitted delegations list further comprising:
reviewing said permitted delegations list to determine whether said delegatee and said task exist in said permitted delegations list.

13. The non-transitory machine readable medium of claim 12, wherein said second user is enabled to specify a subset of a full set of tasks to be delegated to said first user, wherein said full set of tasks represent all tasks enabled to be performed by said second user and delegable by said second user, and said subset of tasks represent a portion of said all tasks,
wherein said subset of tasks correspond to said first plurality of tasks.

14. The non-transitory machine readable medium of claim 9, wherein an application component of said enterprise application is extended with a new set of tasks,
wherein said new set of tasks are automatically available to said administrator to specify whether any of said new set of tasks can be delegated, wherein any of said new set of tasks specified as being eligible for delegation are thereafter automatically available for said delegator to delegate.

15. A server system comprising:
one or more processors; and
a random access memory (RAM) to store instructions,
wherein said one or more processors retrieve said instructions and execute said instructions, wherein execution of said instructions causes said server system to perform the actions of:
receiving from an administrator data specifying a first set of tasks that can be delegated and a class of permissible delegatees to whom said first set of tasks can be delegated;
adding said first set of tasks and said class of delegatees to a permitted delegations list;
receiving a first request from a delegator to delegate a task to a delegatee;
examining said permitted delegations list to determine whether said first request is permitted; and
adding said task and said delegatee to a delegated list if said first request is permitted.

16. The server system of claim 15, wherein said actions further comprise:
receiving a second request from a first user to operate as a delegatee for a second user;
examining said delegated list to determine whether said first user is permitted to be a delegatee for said second user; and
enabling said first user to operate as said delegatee for said second user for a first plurality of tasks indicated to be delegated to said first user by said second user in said delegated list.

17. The server system of claim 16, wherein said first user is enabled to operate as said delegatee without having to provide said second user's authentication information, wherein said actions further comprise permitting said first user to switch between performing a first set of tasks as said second user and a second set of tasks as said first user without said first user being required to authenticate again for said switching.

18. The server system of claim 17, said actions further comprise enabling said second user to review actions corresponding to said first set of tasks performed by said first user as said delegatee.

19. The server system of claim 18, wherein said second user is enabled to specify a subset of a full set of tasks to be delegated to said first user, wherein said full set of tasks represent all tasks enabled to be performed by said second user and delegable by said second user, and said subset of tasks represent a portion of said all tasks,
wherein said subset of tasks correspond to said first plurality of tasks.

20. The server system of claim 16, wherein an application component of said enterprise application is extended with a new set of tasks,
wherein said new set of tasks are automatically available to said administrator to specify whether any of said new set of tasks can be delegated, wherein any of said new set of tasks specified as being eligible for delegation are thereafter automatically available for said delegator to delegate.
